(19) United States
(12) Patent Application Publication
(10) Pub. No.: US 2025/0308194 A1
(43) Pub. Date: Oct. 2, 2025

(54) DEFENSES FOR ATTACKS AGAINST NON-MAX SUPPRESSION (NMS) FOR OBJECT DETECTION

(71) Applicant: QUALCOMM Incorporated, San Diego, CA (US)

(72) Inventors: Jonathan PETIT, Wenham, MA (US); Jean-Philippe MONTEUUIS, Northborough, MA (US); Senthil Kumar YOGAMANI, Galway (IE); Cong CHEN, San Diego, CA (US); Varun RAVI KUMAR, San Diego, CA (US)

(21) Appl. No.: 18/624,994

(22) Filed: Apr. 2, 2024

(51) Int. Cl. G06V 10/26; G06F 21/55; G06V 10/22; G06V 10/70; G06V 20/58

(52) U.S. Cl. CPC G06V 10/267; G06F 21/554; G06V 10/22; G06V 10/768; G06V 20/58; G06F 2221/034

(57) ABSTRACT

Systems and techniques are described for object detection. For example, a computing device can apply a transformation to an image of a scene to generate a transformed image. The computing device can determine a plurality of candidate bounding regions for the transformed image. Each candidate bounding region is associated with an object in the scene. The computing device can determine a subset of candidate bounding regions for the transformed image by removing, using a non-max suppression model, at least one candidate bounding region of the plurality of candidate bounding regions. The computing device can generate an output bounding box for the object based on the subset of candidate bounding regions. The computing device can output the output bounding box. In some cases, the computing device can use an output of an image processing operation on the image to reduce a number of the plurality of candidate bounding regions.

### FIELD

The present disclosure generally relates to object detection. For example, aspects of the present disclosure relate to defenses for attacks (e.g., latency attacks) against non-max suppression (NMS) for object detection.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Object detection can be used to identify an object (e.g., from a digital image or a video frame of a video clip). In some cases, object tracking can be performed to track the object over time (e.g., over a number of frames). Object detection and/or tracking can be used in different fields, including transportation, video analytics, security systems, robotics, aviation, among many others. In some fields, a tracking object (e.g., a vehicle) can determine positions of other objects (e.g., target objects) in an environment so that the tracking object can accurately navigate through the environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for object detection (e.g., applying defenses for latency attacks against non-max suppression for object detection). According to at least one example, an apparatus for object detection is provided. The apparatus includes a memory and a processor coupled to the memory and configured to: apply a transformation to an image of a scene to generate a transformed image; determine, using an object detection model, a plurality of candidate bounding regions for the transformed image, wherein each candidate bounding region of the plurality of candidate bounding regions is associated with an object in the scene; determine a subset of candidate bounding regions for the transformed image by removing, using a non-max suppression model, at least one candidate bounding region of the plurality of candidate bounding regions; generate an output bounding box for the object based on the subset of candidate bounding regions; and output the output bounding box.

In another illustrative example, a method is provided for object detection. The method includes: applying a transformation to an image of a scene to generate a transformed image; determining, using an object detection model, a plurality of candidate bounding regions for the transformed image, wherein each candidate bounding region of the plurality of candidate bounding regions is associated with an object in the scene; determining a subset of candidate bounding regions for the transformed image by removing, using a non-max suppression model, at least one candidate bounding region of the plurality of candidate bounding regions; generating an output bounding box for the object based on the subset of candidate bounding regions; and outputting the output bounding box.

In another illustrative example, a non-transitory computer-readable medium is provided having stored thereon instructions that, when executed by a processor, cause the processors to: apply a transformation to an image of a scene to generate a transformed image; determine, using an object detection model, a plurality of candidate bounding regions for the transformed image, wherein each candidate bounding region of the plurality of candidate bounding regions is associated with an object in the scene; determine a subset of candidate bounding regions for the transformed image by removing, using a non-max suppression model, at least one candidate bounding region of the plurality of candidate bounding regions; generate an output bounding box for the object based on the subset of candidate bounding regions; and output the output bounding box.

In another illustrative example, an apparatus for object detection is provided. The apparatus includes: means for applying a transformation to an image of a scene to generate a transformed image; means for determining, using an object detection model, a plurality of candidate bounding regions for the transformed image, wherein each candidate bounding region of the plurality of candidate bounding regions is associated with an object in the scene; means for determining a subset of candidate bounding regions for the transformed image by removing, using a non-max suppression model, at least one candidate bounding region of the plurality of candidate bounding regions; means for generating an output bounding box for the object based on the subset of candidate bounding regions; and means for outputting the output bounding box.

In another illustrative example, an apparatus for object detection is provided. The apparatus includes a memory and a processor coupled to the memory and configured to: determine, using an object detection model, a plurality of candidate bounding regions within an image of a scene, wherein each candidate bounding region of the plurality of candidate bounding regions is associated with an object in the scene; generate a subset of candidate bounding regions by reducing, based on an output of an image processing operation on the image, a number of the plurality of candidate bounding regions; generate an output bounding box for the object by removing, using a non-max suppression model, at least one candidate bounding region of the subset of candidate bounding regions; and output an object detection output including the output bounding box.

In another illustrative example, a method is provided for object detection. The method includes: determining, using an object detection model, a plurality of candidate bounding regions within an image of a scene, wherein each candidate bounding region of the plurality of candidate bounding regions is associated with an object in the scene; generating a subset of candidate bounding regions by reducing, based on an output of an image processing operation on the image, a number of the plurality of candidate bounding regions; generating an output bounding box for the object by removing, using a non-max suppression model, at least one candidate bounding region of the subset of candidate bounding regions; and outputting an object detection output including the output bounding box.

In another illustrative example, a non-transitory computer-readable medium is provided having stored thereon instructions that, when executed by a processor, cause the processors to: determine, using an object detection model, a plurality of candidate bounding regions within an image of a scene, wherein each candidate bounding region of the plurality of candidate bounding regions is associated with an object in the scene; generate a subset of candidate bounding regions by reducing, based on an output of an image processing operation on the image, a number of the plurality of candidate bounding regions; generate an output bounding box for the object by removing, using a non-max suppression model, at least one candidate bounding region of the subset of candidate bounding regions; and output an object detection output including the output bounding box.

In another illustrative example, an apparatus for object detection is provided. The apparatus includes: means for determining, using an object detection model, a plurality of candidate bounding regions within an image of a scene, wherein each candidate bounding region of the plurality of candidate bounding regions is associated with an object in the scene; means for generating a subset of candidate bounding regions by reducing, based on an output of an image processing operation on the image, a number of the plurality of candidate bounding regions; means for generating an output bounding box for the object by removing, using a non-max suppression model, at least one candidate bounding region of the subset of candidate bounding regions; and means for outputting an object detection output including the output bounding box.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described herein is, can be part of, or can include a mobile device, a smart or connected device, a camera system, and/or an extended reality (XR) device (e.g., a virtual reality (VR) device, an augmented reality (AR) device, or a mixed reality (MR) device). In some examples, each apparatus can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus may include an image sensor (e.g., a camera) or multiple image sensors (e.g., multiple cameras) for capturing one or more images. In some aspects, each apparatus may include one or more displays for displaying one or more images, notifications, and/or other displayable data. In some aspects, each apparatus may include one or more speakers, one or more light-emitting devices, and/or one or more microphones. In some aspects, each apparatus may include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example implementation of a system-on-a-chip (SoC), in accordance with some aspects.

FIG. 2A is a diagram illustrating an example of a fully connected neural network, in accordance with some aspects.

FIG. 2B is a diagram illustrating an example of a locally connected neural network, in accordance with some aspects.

FIG. 2C is a diagram illustrating an example of a convolutional neural network, in accordance with some aspects.

FIG. 3 is a diagram illustrating an example of post-processing performed on a heatmap, in accordance with some aspects.

FIG. 4 is a diagram illustrating example images showing operation of non-max suppression (NMS) on an image for object detection, in accordance with some aspects.

FIG. 5 is a diagram illustrating an example image including many candidate bounding regions generated as a result of an NMS attack, in accordance with some aspects.

FIG. 6 is a diagram illustrating an example of a process for object detection that includes defenses for latency attacks against NMS, in accordance with some aspects.

FIG. 7 is a diagram illustrating example images showing the generation of additional candidate bounding regions as a result of an NMS attack, in accordance with some aspects.

FIG. 8 is a diagram illustrating examples of the effects of applying compression to various different images, in accordance with some aspects.

FIG. 9 is a diagram illustrating an example segmentation map generated from an image, in accordance with some aspects.

FIG. 10 are graphs illustrating example probability distribution functions for a density of candidate bounding regions for different object classes and for a size of candidate bounding regions, respectively, in accordance with some aspects.

FIG. 11 is a diagram illustrating an example of reducing a number of candidate bounding regions using a segmentation mask, in accordance with some aspects.

FIG. 12 is a diagram illustrating an example of the effects of an NMS attack on a segmentation mask, in accordance with some aspects.

FIG. 13A is a flow diagram illustrating an example of a process for object detection, in accordance with some aspects.

FIG. 13B is a flow diagram illustrating another example of a process for object detection, in accordance with some aspects.

FIG. 14 is a block diagram illustrating an example of a deep learning network, in accordance with some aspects.

FIG. 15 is a block diagram illustrating an example of a convolutional neural network, in accordance with some aspects.

FIGS. 16A, 16B, and 16C are diagrams illustrating an example of a single-shot object detector, in accordance with some aspects.

FIGS. 17A, 17B, and 17C are diagrams illustrating an example of a you only look once (YOLO) detector, in accordance with some aspects.

FIG. 18 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Various systems and devices (e.g., autonomous vehicles, such as autonomous and semi-autonomous cars, drones, mobile robots, mobile devices, extended reality (XR) devices, and other suitable systems or devices) include multiple sensors (e.g., camera sensors) to gather sensor information about the environment. Such systems and devices may also include processing systems to process the sensor information, such as for route planning, navigation, collision avoidance, environment modelling/rendering, etc. For example, camera sensors are used in automated driving for detecting, classifying, and tracking objects within the environment.

Object detectors (ODs) are algorithms (e.g., machine learning algorithms) that are used to detect objects in an image frame (e.g., obtained by one or more camera sensors). An object detector can output a large number (e.g., thousands in some cases) of candidate bounding regions. For example, a bounding region may be in the form of a bounding box (bbox). Currently, one function to reduce the number of candidate (e.g., redundant) bounding regions is non-max suppression (NMS). NMS can be used to reduce the number of candidate bounding regions (e.g., bounding boxes) so that only candidate bounding regions with a high probability of containing an object are processed or output as an object detection output.

In some cases, attacks may be performed to target ODs that use NMS. For example, an attack on NMS may include crafting perturbations to maximize the number of relevant candidate bounding regions. Such an attack can be referred to as a latency attack, which can increase the latency of perception pipeline (e.g., in some cases by sixteen times (16×)) and can dramatically reduce an accuracy or precision (e.g., a mean average precision) for object detection. Improved systems and techniques that provide defenses to mitigate, detect, and react to NMS attacks can be beneficial.

In one or more aspects, systems, apparatuses, processes (also referred to as methods), and computer-readable media (collectively referred to herein as “systems and techniques”) are described herein for providing defenses for attacks (e.g., latency attacks) against NMS for object detection. In one or more examples, the systems and techniques detect and/or prevent attacks on NMS using one or more security techniques positioned before an object detection model (which can also be referred to as an object detector model) and/or one or more security models positioned after the object detection model. In some aspects, the systems and technique can adaptively select where to run the security model(s) (e.g., whether to run a security model before or after the object detection model).

In one or more examples, defenses before the object detection model can include transformations (e.g., blurring, masking, inpainting, application of a diffusion machine learning model (e.g., a stable diffusion neural network model or other type of diffusion neural network model), compression, or other transformation(s)) to reduce the effectiveness of various attacks. The type(s) of transformations to be utilized can be selected based on, for example, context of a scene, luminance of one or more images of the scene, a type of environment associated the scene (e.g., a highway environment, urban environment, etc.) or characteristic of the environment associated the scene (e.g., number of objects, etc.), among other factors.

In some examples, defenses after the object detection model can include a threshold on the number of bounding boxes. In one or more examples, the threshold number can be dynamic. In some examples, the threshold number can be based on context, plausibility determination based on a probability distribution function, and/or comparisons to other detectors and/or tasks. In one or more examples, the NMS attack detector (e.g., whether to include the security model before and/or after the object detection model) can be determined based on, for example, the perception task, performance requirements, etc.

In one or more aspects, during operation of the systems and techniques for object detection, one or more processors can apply one or more transformations to one or more images of a scene to generate one or more transformed images. The one or more processors can use an object detection model to determine a plurality of candidate bounding regions for the one or more transformed images. In one or more examples, each candidate bounding region of the plurality of candidate bounding regions can be associated with a respective object of one or more objects in the scene. The one or more processors can use a non-max suppression model to remove one or more candidate bounding regions of the plurality of candidate bounding regions to generate output bounding boxes for the one or more objects. The one or more processors can output an object detection output that can include the output bounding boxes.

In one or more examples, one or more image sensors (e.g., one or more camera sensors) can obtain the one or more images of the scene. In one or more examples, the one or more processors can determine, based on a context of the scene, at least one transformation of the one or more transformations (e.g., blurring, masking, inpainting, application of a diffusion machine learning model, compression, etc.) to apply to the one or more images. In some examples, the context of the scene can be based on luminance of the one or more images, brightness of the one or more images, and/or a type of environment of the scene. In one or more examples, the type of environment of the scene can be a highway environment or an urban environment.

In some examples, the one or more processors can output a warning message indicating a detected attack based on the plurality of candidate bounding regions being greater than a threshold number of candidate bounding regions. In one or more examples, the threshold number of candidate bounding regions can be based on a context of the scene and/or a plausibility determination based on a probability distribution function of objects within an environment of the scene.

In one or more examples, the one or more processors can use an output of one or more image processing operations on the one or more images to reduce a number of the plurality of candidate bounding regions. In some examples, the output of one or more image processing operations or tasks on the one or more images can include a segmentation mask (e.g., generated by a semantic segmentation or instance segmentation model, such as a neural network model), an attention map, and/or a known low-density region.

In some examples, the one or more processors can determine whether to apply a threshold number of candidate bounding regions and/or an output of one or more image processing operations (e.g., a segmentation mask, an attention map, a known low-density region, etc.) on the one or more images, based on a perception task for detecting the one or more objects and/or one or more performance requirements. In one or more examples, the perception task can include detecting objects on a road within an environment of the scene for an autonomous driving application. In some examples, the one or more performance requirements can include a latency requirement.

In some aspects, during operation of the systems and techniques for object detection, one or more processors can determine, using an object detection model, a plurality of candidate bounding regions within one or more images of a scene. In one or more examples, each candidate bounding region of the plurality of candidate bounding regions can be associated with a respective object of one or more objects in the scene. The one or more processors can reduce, based on an output of one or more image processing operations on the one or more images, a number of the plurality of candidate bounding regions to generate a subset of candidate bounding regions. The one or more processors can remove, using a non-max suppression model, one or more candidate bounding regions of the subset of candidate bounding regions to generate output bounding boxes for the one or more objects. The one or more processors can output an object detection output including the output bounding boxes.

In one or more examples, one or more image sensors (e.g., camera sensors) can obtain the one or more images of the scene. In some examples, the one or more processors can output a warning message indicating a detected attack, based on the plurality of candidate bounding regions being greater than a threshold number of candidate bounding regions. In one or more examples, the threshold number of candidate bounding regions can be based on a context of the scene and/or a plausibility determination based on a probability distribution function of objects within an environment of the scene. In some examples, the output of the one or more image processing operations on the one or more images can include a segmentation mask, an attention map, and/or a known low-density region.

In some examples, the one or more processors can apply one or more transformations to the one or more images of the scene. In one or more examples, the one or more transformations can include blurring, masking, inpainting, application of a diffusion machine learning model, and/or compression. In some examples, the one or more processors can determine, based on a context of the scene, at least one transformation of the one or more transformations to apply to the one or more images. In one or more examples, the context of the scene can be based on luminance of the one or more images, brightness of the one or more images, and/or a type of environment of the scene. In some examples, the type of environment of the scene can be a highway environment or an urban environment.

In one or more examples, the one or more processors can determine whether to apply the one or more transformations to the one or more images, based on a perception task for detecting the one or more objects and/or one or more performance requirements. In some examples, the perception task can include detecting objects on a road within an environment of the scene for an autonomous driving application. In one or more examples, the one or more performance requirements can include a latency requirement.

Additional aspects of the present disclosure are described in more detail below.

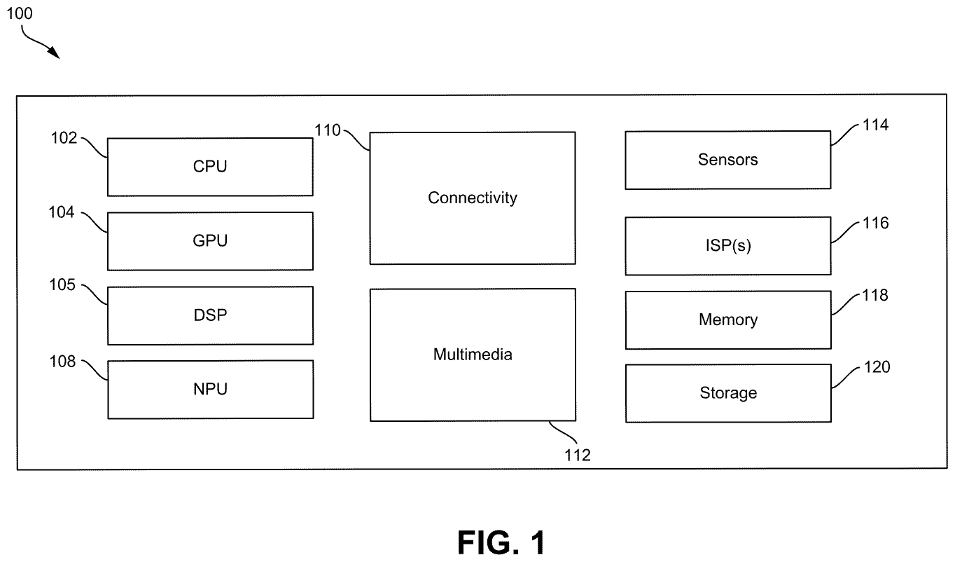

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 105, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 105, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 105, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 105, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 105, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 105, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

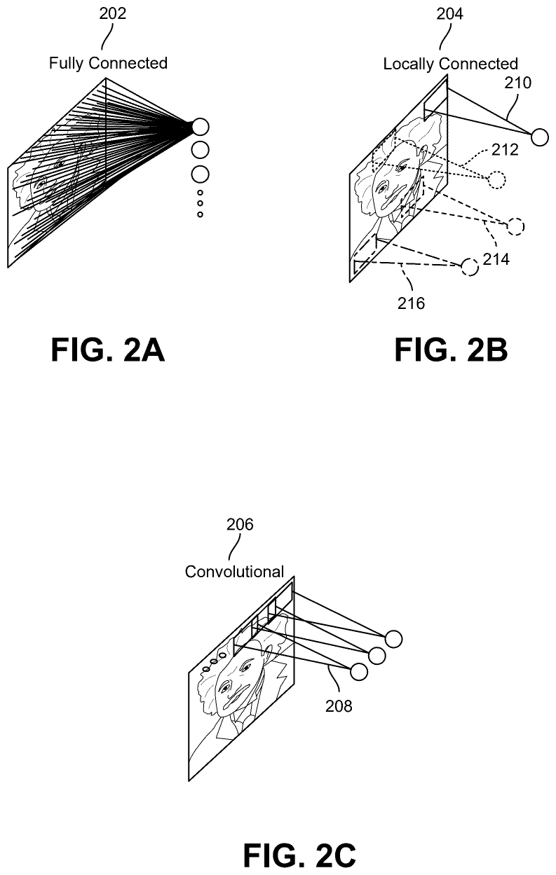

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

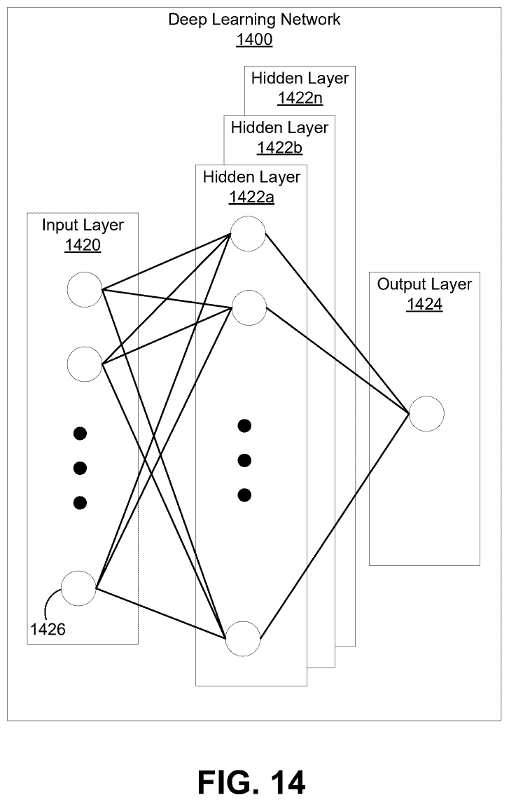

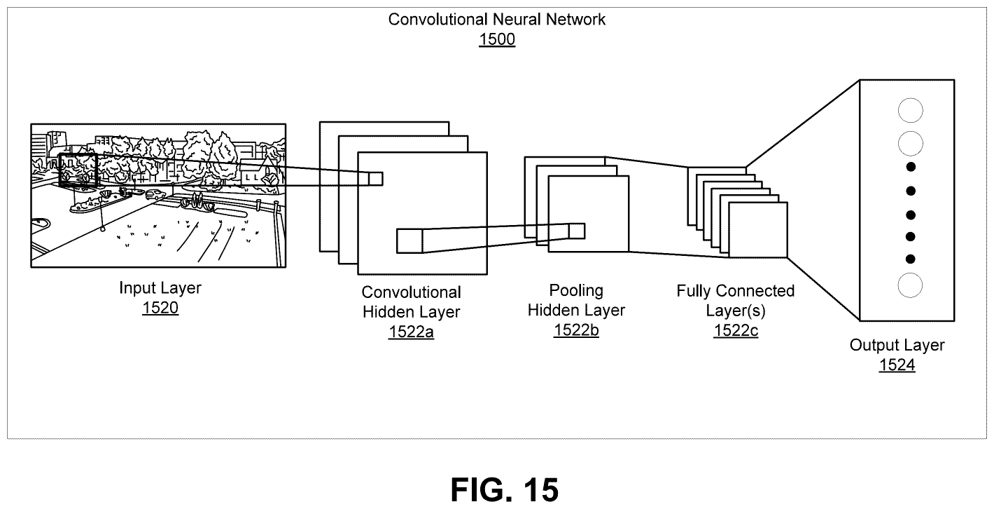

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 14. An illustrative example of a convolutional neural network is described in greater depth with respect to the example block diagram of FIG. 15.

As mentioned previously, a machine learning system (e.g., a deep neural network system or model, such as that described with respect to FIG. 2A-2C, FIG. 14, and/or FIG. 15) can be used to perform object detection (e.g., two-dimensional (2D) object detection or three-dimensional (3D) object detection), for example, by processing one or more images and detecting one or more objects in the image(s). A machine learning system trained to perform object detection can be referred to herein as an object detection machine learning system or model.

In object detection, a location of an object can be defined or described by a bounding box (bbox) or other bounding region (e.g., a bounding ellipse, a bounding square, etc.). A bounding box will be used herein as an illustrative example of a bounding region. In some cases, a bounding box can be defined or represented as a center position (e.g., with a horizontal or x-coordinate and a vertical or -y coordinate, denoted as (x,y)), height, and width. In some cases, 3D object detection can be performed, in which case the bounding box can also have a depth (e.g., in the depth or z-dimension)

In some aspects, to generate a bounding box, a system may include a bounding box encoding engine (e.g., a bounding box encoding engine). For instance, the bounding box encoding engine can perform a post-processing step on one or more outputs of an object detection machine learning system (e.g., an object detection neural network model). In some cases, the bounding box encoding engine can select center positions with the K highest scores in an image, where K is equal to or greater than 1. In some cases, the bounding box encoding engine can use a topK operation to select the center positions with the K highest scores.

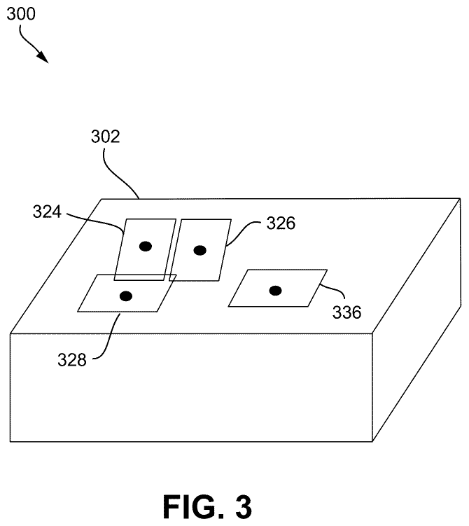

FIG. 3 is a diagram illustrating an example of post-processing performed on an image by a bounding box encoding engine. As illustrated in FIG. 3, an image 302 is output from an object detection machine learning system (e.g., an object detection neural network model). The bounding box encoding engine can then find positions in the image 302 where objects might exist, such as by performing a topK operation to select the K highest scores.

The bounding box encoding engine can assign K bounding boxes to the K points. In the example of FIG. 3, K=4, in which case the bounding box encoding engine can assign the K bounding boxes 324, 326, 328, and 336 to the K points. For instance, the bounding box encoding engine can regress the K boxes using predicted box attributes (also referred to as box attributions). In some aspects, the predicted box attributes can be output by the object detection machine learning system along with one or more images (e.g., image 302). In some cases, the predicted box attributes can include a width and height of each bounding box associated with a respective point (e.g., a width and height of the bounding box 324 associated with a point, a width and height of the bounding box 326 associated with a point, and so on), a rotation angle of each bounding box, an index value associated with a point and corresponding bounding box (e.g., an index value associated with a point and corresponding bounding box 328).

The bounding box encoding engine can then determine or select a single most confident bounding box (e.g., with the highest confidence score) from any overlapping bounding boxes to include in an object detection output. In one illustrative example, the bounding box encoding engine can perform Non-Maximum Suppression (NMS) to select a single bounding box from the overlapping bounding boxes.

The NMS operation can operate using a set of bounding box proposals (denoted as BB_{P}), a confidence score for each bounding box (denoted as S_{BB}), and overlap threshold (denoted as O_{Th}) as input, and can output a final set of bounding boxes (BB_{F}). For example, using the NMS operation, the bounding box encoding engine can select the proposal with the highest confidence score (denoted as BB₁), remove it from the proposals BB_{P}, and add it to the final set of bounding boxes BB_{F}. The bounding box encoding engine can then compare the proposal bounding box BB₁ with all of the bounding box proposals, such as by calculating the intersection-over-union (IoU) of the proposal BB₁ with every other proposal. If the IoU is greater than the threshold O_{T}h, the proposal BB₁ can be removed from the set of proposals BB_{P}. The bounding box encoding engine can then take the proposal in the updated set of proposals BB_{P} with the highest confidence (denoted to as BB₂) and remove the proposal BB₂ from BB_{P} and add the proposal BB₂ to BB_{F}. The bounding box encoding engine can calculate the IoU of the proposal BB₂ with all the proposals in BB_{P} and eliminate the boxes which have an IoU greater than the threshold O_{T}h. This NMS operation can be repeated until there are no longer any proposals left in BB_{P}.

As previously mentioned, currently, systems and devices (e.g., autonomous vehicles, such as autonomous and semi-autonomous cars, drones, mobile robots, mobile devices, extended reality (XR) devices, and other suitable systems or devices) increasingly include multiple sensors (e.g., camera sensors) to gather information about the environment, as well as processing systems to process the information gathered (e.g., for route planning, navigation, collision avoidance, environment modelling/rendering, etc.). For example, camera sensors are used in automated driving for detecting, classifying, and tracking objects within the environment.

Object detectors (ODs) are algorithms, based on machine learning, that are used to detect objects within an image frame, which may be obtained by one or more camera sensors. An object detector may output thousands of candidate bounding regions (e.g., which can each be in the form of a candidate bounding box (bbox)). Currently, one function to reduce the number of candidate (e.g., redundant) bounding regions (e.g., in order to process only candidate bounding regions with a high probability to contain an object) is non-max suppression (NMS). An attack on NMS (e.g., an NMS attacked) generates perturbations to maximize the number of relevant candidate bounding regions. Such an attack can increase the latency of NMS, such as an increase by sixteen times (16×), and can dramatically reduce the mean average precision for object detection. There are existing solutions to address these NMS attacks. However, these existing solutions do not include defenses to mitigate, detect, and react to NMS attacks. Therefore, improved systems and techniques that provide defenses to mitigate, detect, and react to NMS attacks can be useful.

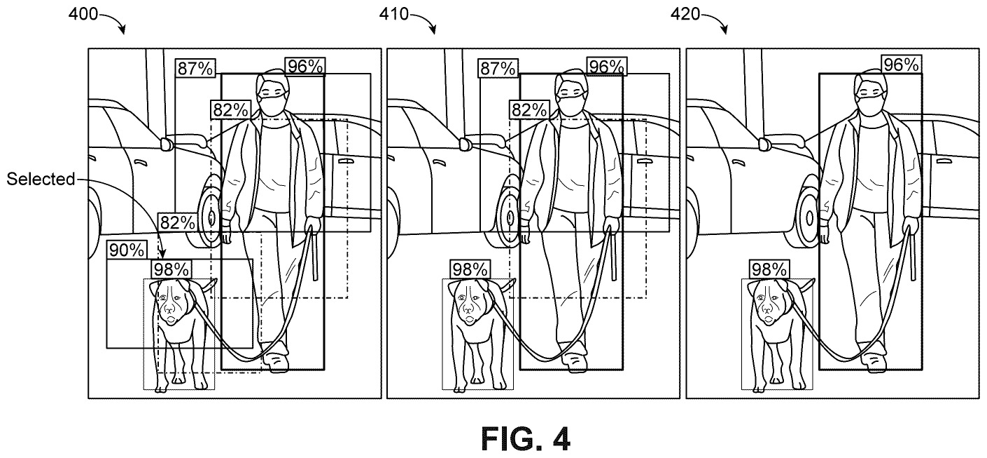

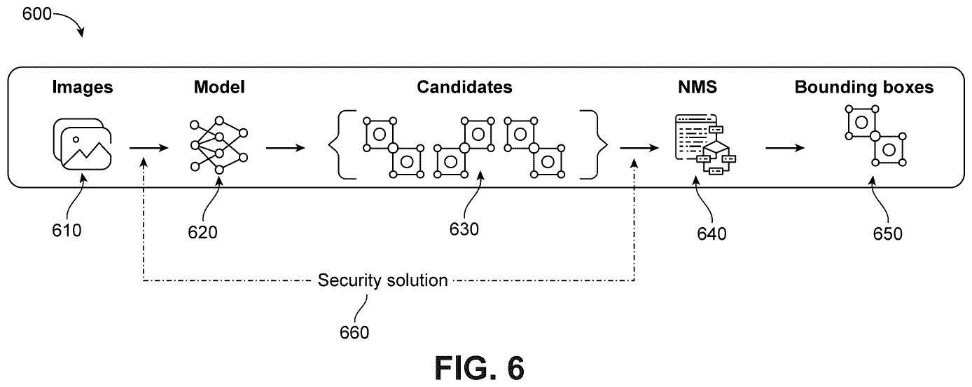

FIG. 4 shows an example of operation of NMS. In particular, FIG. 4 is a diagram illustrating example images 400, 410, 420 showing operation of NMS (e.g., NMS model 640 of FIG. 6) on an image for object detection.

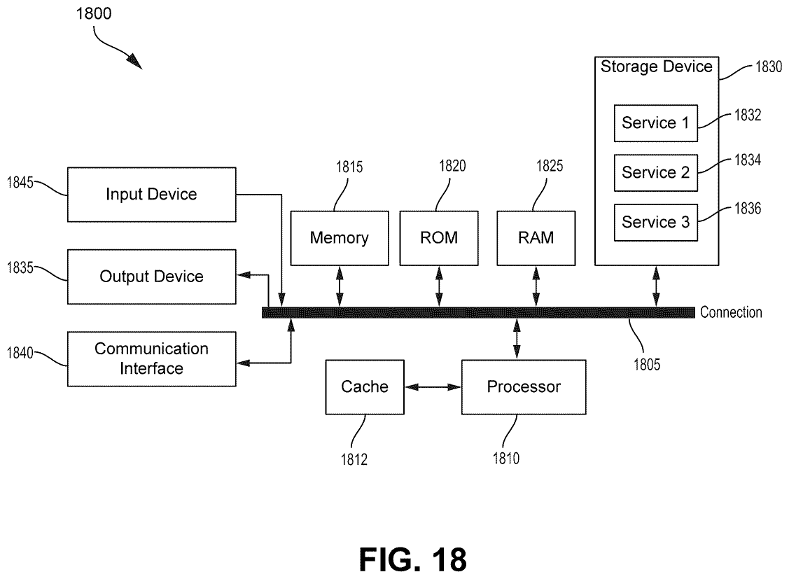

For the example of FIG. 4, one or more image sensors (e.g., one or more camera sensors) can obtain an image of a scene. The scene can include a dog and a person, as shown in FIG. 4. The image can be input into an object detection model (e.g., object detection model 620 of FIG. 6). One or more processors (e.g., processor 1810 of FIG. 18) using the object detection model can generate, based on the image of the scene, a plurality of candidate bounding regions. In one or more examples, each candidate bounding region has an associated probability (e.g., a confidence score) that an object is present (e.g., exists) within the candidate bounding region. In one or more examples, each candidate bounding region may be in the form of a candidate bounding box, as is shown in FIG. 4. Image 400 of FIG. 4 shows an example output of an object detection model. In particular, image 400 shows a number of candidate bounding boxes overlaying two detected objects (e.g., a dog and a person) within the scene.

During operation of NMS (e.g., NMS model 640 of FIG. 6), one or more processors using NMS can filter out low confidence objects (e.g., candidate bounding regions with low confidence scores). In FIG. 4, image 410 shows the result of NMS filtering out low confidence candidate bounding regions. For example, image 410 shows that a candidate bounding region with a confidence score of eight-two (82) percent (%) in image 400 has been removed.

The one or more processors using NMS can then sort the candidate bounding regions. The one or more processors using NMS can calculate pairwise (e.g., a calculation per each pair of candidate bounding regions) intersection over union (IoU) scores. Each calculated pairwise IoU score can indicate an amount of overlap of the two candidate bounding regions within the pair. The one or more processors using NMS can then remove one of the candidate bounding regions of a pair of candidate bounding regions that has a high IoU score (e.g., indicating a large amount of overlap of the two candidate bounding regions). For example, image 420 shows that a candidate bounding region with a confidence score of eighty-two (82) % (e.g., which has a large amount of overlap with a candidate bounding region with a confidence score of ninety-six (96) % in image 410) has been removed. For another example, image 420 shows that a candidate bounding region with a confidence score of eighty-seven (87) % (e.g., which has a large amount of overlap with the candidate bounding region with a confidence score of 96% in image 410) has been removed. For yet another example, image 420 shows that a candidate bounding region with a confidence score of ninety (90) % (e.g., which has a large amount of overlap with a candidate bounding region with a confidence score of ninety-eight (98) % in image 410) has been removed. The one or more processors using NMS can also prune inactive objects.

In one or more examples, NMS can use overlap area, aspect ratio, and/or distance between candidate bounding regions (e.g., candidate bounding boxes) to make candidate bounding region suppression decisions. The most time-consuming tasks in NMS can be the calculation of the pairwise IoU scores (e.g., because they are done on a one-to-one basis using pairs of candidate bounding regions) and the pruning of inactive objects. In some examples, these tasks can have an order of complexity of (O(|S|²)). In one or more examples, different types of NMS may be employed for NMS (e.g., NMS model 640 of FIG. 6). The different types of NMS that may be employed may include, but are not limited to, a double threshold NMS, a soft NMS, a greedy NMS, an adaptive NMS, and/or a multi-attribute (MA) NMS.

In one or more aspects, NMS may use various different vision tasks, which can include NMS using object detectors, instance segmentation, keypoint detection/pose estimation, and/or object tracking. For example, for object tracking, NMS can be applied on predicted bounding regions (e.g., bounding boxes) to eliminate duplicate bounding regions. For another example, for instance segmentation, after predicting masks for each instance, NMS can be used to suppress overlapping masks, which can ensure that each instance has only one mask. For another example, for keypoint detection/pose estimation, after predicting keypoints, NMS can be applied to suppress multiple detections of the same keypoint. For yet another example, for object tracking, when tracking objects across image frames, NMS can be used to associate detections to tracks and discard any overlapping tracks.

In one or more aspects, there can be various different latency attacks launched against NMS. These latency NMS attacks can include, but are not limited to, Daedalus attacks, PhantomSponge attacks, and/or Overload attacks. In one or more examples, the goal of a Daedalus attack is to disable NMS by causing fake candidate bounding regions to be unfiltered by NMS. A Daedalus attack can achieve this by maximizing confidence scores of candidate bounding regions and/or by minimizing IoU scores of each pair of candidate bounding regions. A Daedalus attack can be applied against any fully convolutional network-based detector. A Daedalus attack can result in a mean average precision (mAP) error dropping from zero (0) to seventeen (17) %.

In some examples, the goal of a PhantomSponge attack is to increase inference latency in the operation of NMS. A PhantomSponge attack can achieve this NMS latency by creating adversarial perturbations that cause a large amount of candidate bounding regions (e.g., bounding boxes) to be created. A PhantomSponge attack has a similar approach as a Daedalus attack. A PhantomSponge attack can increase an inference time of NMS by forty-five (45) % (e.g., a frame per second rate can drop from forty (40) to six (6) frames per second).

In one or more examples, the goal of an Overload attack is to increase inference latency in the operation of NMS. An Overload attack can achieve this NMS latency by generating adversarial perturbations that can manipulate the distributions of boxes in different regions of an image. This spatial attention can force the detector to pay more attention to low-density regions. An Overload attack can increase an inference time of NMS by thirteen-hundred (1300) %.

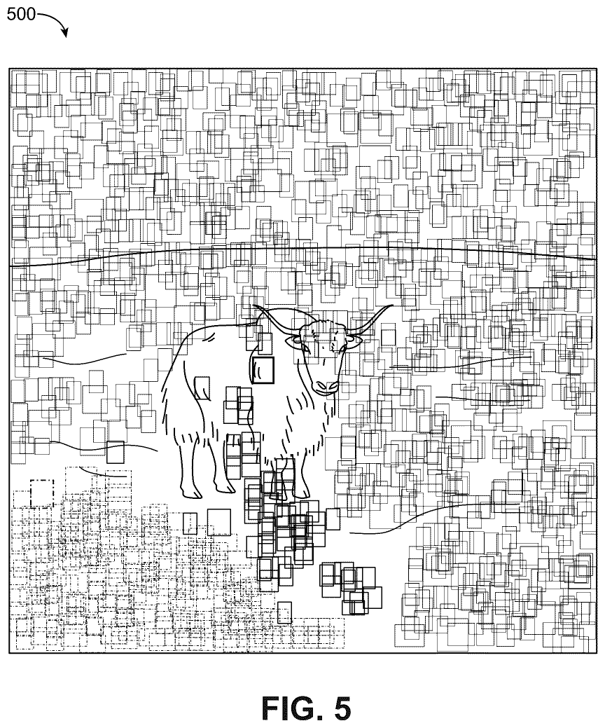

FIG. 5 shows an example of results from an Overload attack. In particular, FIG. 5 is a diagram illustrating an example image 500 including many candidate bounding regions generated as a result of an NMS attack (e.g., an Overload attack). In FIG. 5, the image is shown to include thousands of candidate bounding regions (e.g., candidate bounding boxes). This excessive number of candidate bounding regions can cause a latency in the operation of NMS.

In one or more aspects, the systems and techniques provide defenses for latency attacks against NMS for object detection. In one or more examples, the systems and techniques focus on the vision task of NMS using object detectors. In some examples, the systems and techniques detect attacks on NMS by employing a security model or solution (e.g., security model 660 of FIG. 6) positioned before and/or after an object detection model (e.g., object detection model 620 of FIG. 6), and use techniques to adaptively select where to run the security model.

In one or more examples, defenses before the object detection model can include transformations, such as blurring, masking, inpainting, application of a diffusion machine learning model, or compression, to reduce the effectiveness of various attacks. The type(s) of transformations to be utilized can be selected based on, for example, context, luminance, environment, etc.

In some aspects, defenses after the object detection model can include a threshold on the number of bounding boxes. In one or more examples, the threshold number can be dynamic. In some examples, the threshold number can be based on context, plausibility determination based on a probability distribution function, and/or comparisons to other detectors and/or tasks. In one or more examples, the NMS attack detector (e.g., whether to include the security model before and/or after the object detection model) can be determined based on, for example, the perception task, performance requirements, etc.

FIG. 6 is a diagram illustrating an example of a process 600 for object detection that includes defenses for latency attacks against NMS. In FIG. 6, an object detection model 620, a security model 660 (e.g., security solution), and an NMS model 640 are shown. For the process 600 of FIG. 6, the security model 660 (e.g., security module) may be positioned (e.g., applied) before and/or after the object detection model 620. The process 600 provides a technique to adaptively select the placement of the security model 660 within the process 600. The process 600 can also output a warning to consuming applications when there is an excessive amount of candidate bounding regions. In one or more examples, the objectives of the process 600 are to reduce the effects of NMS attacks (e.g., by reducing the number of candidate bounding regions input into the NMS model 640, and/or by reducing the adversarial input), and to detect NMS attacks.

In FIG. 6, during operation of the process 600 for object detection, one or more image sensors (e.g., one or more camera sensors) can obtain one or more images 620 of a scene. In one or more examples, for example when the security model 660 is applied before the object detection model 620, one or more processors (e.g., processors 1810 of FIG. 18), using the security model 660, can apply one or more transformations to the one or more images 610 of the scene to generate one or more transformed images. In some examples, the one or more transformations can include blurring, masking, inpainting, application of a diffusion machine learning model, and/or compression. In one or more examples, the one or more processors can determine, based on a context of the scene, at least one transformation of the one or more transformations to apply to the one or more images 610. In some examples, the context of the scene can be based on luminance of the one or more images 610, brightness of the one or more images 610, and/or a type of environment of the scene. In one or more examples, the type of environment of the scene can be a highway environment or an urban environment.

The one or more processors can then use the object detection model 620 to determine a plurality of candidate bounding regions 630 (e.g., bounding boxes (bboxes)) for the one or more transformed images. In examples where the security model 660 is not applied before the object detection model 620, the one or more processors can use the object detection model 620 to determine a plurality of candidate bounding regions 630 for the one or more images 610. In one or more examples, each candidate bounding region 630 of the plurality of candidate bounding regions 630 can be associated with a respective object of one or more objects in the scene.

In one or more examples, for example when the security model 660 is applied after the object detection model 620, one or more processors, using the security model 660, can reduce, based on an output of one or more image processing operations on the one or more images 610, a number of the plurality of candidate bounding regions 630 to generate a subset of candidate bounding regions. In some examples, the output of the one or more image processing operations on the one or more images 610 can include a segmentation mask, an attention map, and/or a known low-density region. For instance, the segmentation mask may be generated by a semantic segmentation or instance segmentation model, such as a neural network model trained to generate semantic segmentation or instance segmentation masks. A low-density region can be determined from prior knowledge. For example, an object detection system can be aware of a number of bounding boxes in a region of an image and can thus know when there are a small number of bounding boxes (e.g., less than three bounding boxes, ten bounding boxes, or other threshold number of bounding boxes) in a certain portion of an image (e.g., in a sky portion or other portion of the image). In some cases, the low-density region can be represented in a mask (e.g., a binary mask) or using any other suitable representation. Attention maps can come from feature maps output by a layer of a neural network, such as a feature extractor. For instance, one or more intermediate feature maps from one or more intermediate layers of a neural network, such one or more pooling layers, can be used to infer attention maps.

In some examples, the one or more processors can output a warning message indicating a detected attack (e.g., an NMS attack), based on the plurality of candidate bounding regions 630 being greater than a threshold number of candidate bounding regions. In some cases, the warning message can be output to a consumer of the object detection model 620 (e.g., an object tracking engine, a sensor fusion engine, a trajectory prediction engine, a V2X module, etc.). In some cases, the warning message can include a region where the perturbation is suspected to be, a numerical value that represent the density of perturbation (e.g., because the consumer might set a threshold to consider if the image is usable or should be dismissed), and/or any other type of warning message or alert. In some examples, the threshold number of candidate bounding regions can be dynamic. In one or more examples, the threshold number of candidate bounding regions can be based on a context of the scene and/or a plausibility determination based on a probability distribution function of objects within an environment of the scene. The threshold number of candidate bounding regions can be determined before the NMS model 640 or after the NMS model 640 has processed the bounding regions from the object detection model 620. For instance, if determined before the object detection model 620, the comparison can be based on the bounding regions output from the object detection model 620. If determined before the object detection model 620, the comparison can be based on bounding regions left over after low-confidence bounding regions have been removed by the NMS model 640.

The one or more processors can then remove, using the NMS model 640, one or more candidate bounding regions 630 of the subset of candidate bounding regions to generate output bounding boxes 650 for the one or more objects. In examples where the security model 660 is not applied after the object detection model 620, the one or more processors can remove, using the NMS model 640, one or more candidate bounding regions 630 of the plurality of candidate bounding regions 630 to generate output bounding boxes 650 for the one or more objects. The one or more processors can then output an object detection output including the output bounding boxes 650.

In one or more examples, the one or more processors can determine whether to apply the security model 660 before and/or after the object detection model 620 based on a perception task for detecting the one or more objects and/or one or more performance requirements. In one or more examples, when the security model 660 is applied before the object detection model 620, the one or more processors can apply the one or more transformations to the one or more images 610. In some examples, when the security model 660 is applied before the object detection model 620, the one or more processors can determine whether to apply a threshold number of candidate bounding regions and/or an output of one or more image processing operations on the one or more images, based on the perception task for detecting the one or more objects and/or one or more performance requirements. In one or more examples, the perception task can include detecting objects on a road within an environment of the scene for an autonomous driving application. In some examples, the one or more performance requirements can include a latency requirement.

In one or more aspects, when the security model 660 is applied before the object detection model 620, to remove and/or diminish adversarial perturbations that affect NMS, the maximization of high probability bounding regions should be canceled and/or reduced. In one or more examples, transformations to the images 610 (e.g., blurring, masking, inpainting, application of a diffusion machine learning model, and/or compression) can reduce adversarial perturbation effectiveness.

In one or more examples, the transformation of blurring can cause one or more objects within the one or more images 610 to be blurred. In some examples, the transformation of masking can cause one or more objects within the one or more images 610 to be masked out with a mask such that the region denoted by the mask does not have any candidate bounding regions. In one or more examples, the transformation of inpainting can cause one or more objects within the one or more images 610 to be removed such that the region(s) of the removal of the one or more objects does not have any candidate bounding regions. In some examples, the transformation using a diffusion machine learning model (e.g., a diffusion neural network, such as a stable diffusion neural network or other type of diffusion neural network) can cause one or more objects within the one or more images 610 to be diffused across the scene. In one or more examples, the transformation of compression (e.g., Joint Photographic Experts Group (JPEG) compression) can cause the removal of redundant candidate bounding regions. As previously mentioned, the type(s) of transformation (e.g., blurring, masking, inpainting, application of a diffusion machine learning model, and/or compression) to be selected (e.g., applied to the one or more images 610) can be context-based (e.g., based on luminance of the images 610, brightness of the images 610, and/or the type of environment of the scene, which may be a highway environment or an urban environment).

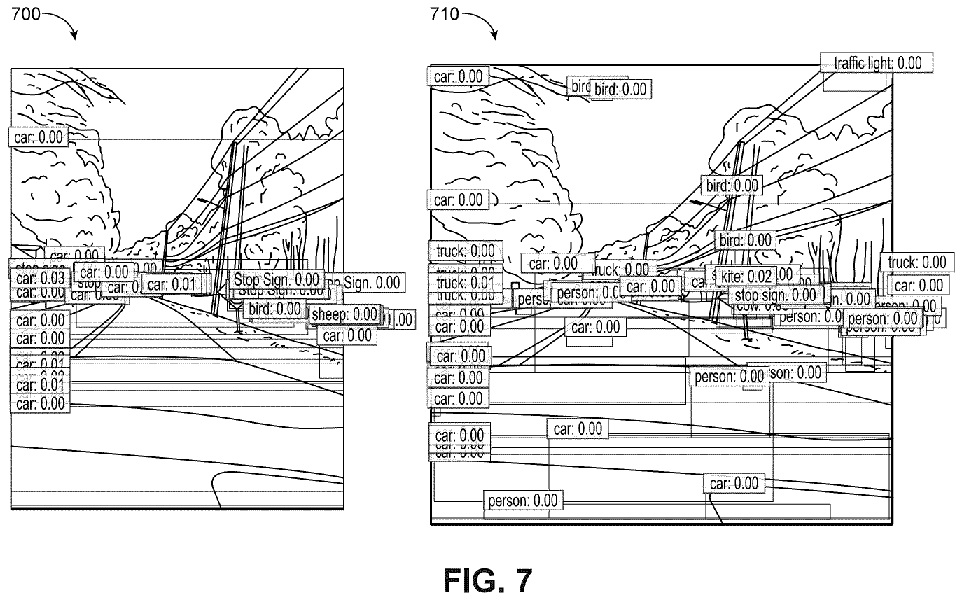

FIG. 7 is a diagram illustrating example images 700, 710 showing the generation of additional candidate bounding regions as a result of an NMS attack. In FIG. 7, image 700 shows a plurality of candidate bounding boxes that are output from an object detection model (e.g., object detection model 620) for objects within an scene without the presence of an NMS attack. Conversely, image 710 shows a plurality of candidate bounding boxes that are output from an object detection model (e.g., object detection model 620) for objects within an scene with an NMS attack (e.g., a Daedalus attack). In FIG. 7, image 710 is shown to have many more redundant bounding regions created than image 700.

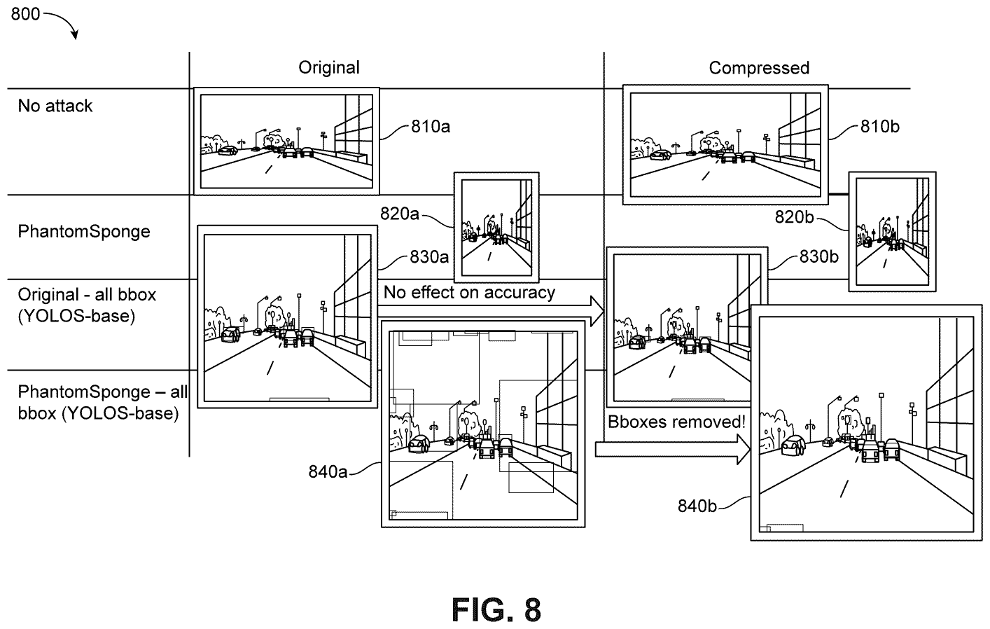

In one or more aspects, the transformation of compression can be applied to one or more images of a scene to reduce the number of redundant candidate bounding regions that may be caused by an NMS attack. FIG. 8 shows examples of the effect of compression of images in reducing the number of redundant candidate bounding regions caused by NMS attacks. In particular, FIG. 8 is a diagram illustrating examples of the effects of applying compression (JPEG) to various different images.

In FIG. 8, for example, an original image 810a with no NMS attack is shown. The image 810a is then compressed (e.g., using JPEG compression) to produce image 810b. Image 810b appears to be very similar to image 810a.

Also in FIG. 8, original image 820a with a PhantomSponge NMS attack is shown. As a result of the PhantomSponge attack, the proportions of the image 820a have changed. The image 820a is then compressed (e.g., using JPEG compression) to produce image 820b. Image 820b appears to be similar to image 820a.

In FIG. 8, image 830a with no NMS attack is shown. Image 830a is shown to include candidate bounding regions (e.g., candidate bounding boxes) that have been generated by an object detection model (e.g., object detection model 660 of FIG. 6). The image 830a is then compressed (e.g., using JPEG compression) to produce image 830b. As a result of the compression, image 830b has similar candidate bounding regions as image 830a. As such, the compression of image 830a to produce 830b has shown to not affect the accuracy of the candidate bounding regions.

Image 840a with a PhantomSponge NMS attack is shown. As a result of the PhantomSponge attack, image 840a is shown to include many redundant candidate bounding regions (e.g., candidate bounding boxes) that have been generated by an object detection model (e.g., object detection model 660 of FIG. 6). The image 840a is then compressed (e.g., using JPEG compression) to produce image 840b. As a result of the compression, image 840b shows that many of the redundant candidate bounding regions of image 840a have been eliminated. As such, as shown by images 840a and 840b, the transformation of compression can be applied to images under NMS attack to effectively remove excess redundant candidate bounding regions.

In one or more aspects, when the security model 660 is applied after the object detection model 620, various different types of NMS attack detectors may be applied. In one or more examples, a first type of NMS attack detector may be applied that places a threshold on the number of candidate bounding regions 630 (e.g., output from the object detection model 620), where there is an indication of an NMS attack when the number of candidate bounding regions 630 (e.g., output from the object detection model 620) exceeds the threshold number. This attack threshold limit can be dynamically adjusted, based on knowledge distillation (e.g., prior knowledge of average numbers of candidate bounding regions for specific types of detected objects) and/or context (e.g., based on luminance of the images 610, brightness of the images 610, and/or the type of environment of the scene, which may be a highway environment or an urban environment). In one or more examples, when the number of candidate bounding regions 630 is greater than the threshold number of candidate bounding regions, one or more processors can output a warning indicating that an NMS attack has been detected.

In one or more examples, a second type of NMS attack detector may be applied where the threshold number of candidate bounding regions is plausibility based on a probability distribution function. In one or more examples, for this second type of detector, one or more regions and/or one or more masks (e.g., applied on top of regions or portions) within the one or more images may be determined for the images, based on one or more tasks (e.g., segmentation, an attention map, and/or a known low-density region within the scene). Each of the regions and/or masks has a probability distribution function. The probability distribution function (e.g., for each of the specific regions and/or masks) may be based on a candidate bounding region density, a candidate bounding region density per object class (e.g., a maximum number of candidate bounding regions for vehicles may be fifteen), a candidate bounding box size (e.g., using anchor candidate bounding regions as a “normal” size), and/or a candidate bounding box size per object class.

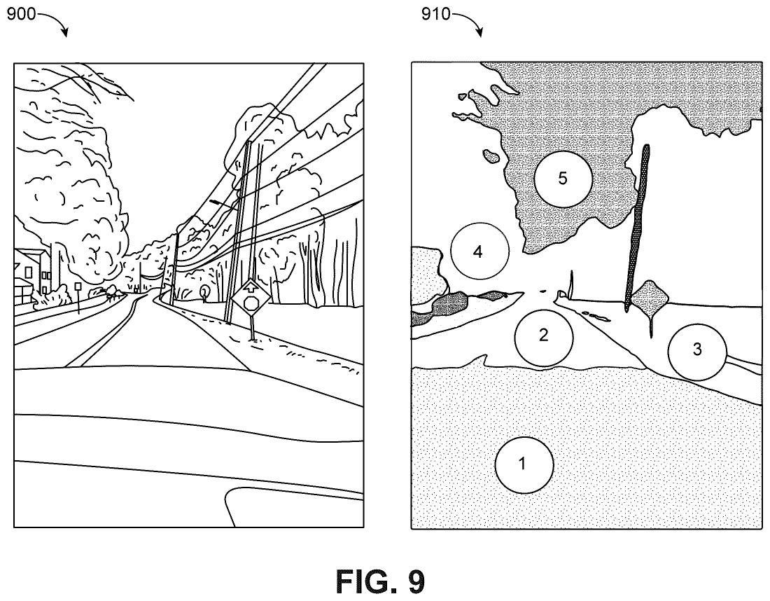

FIG. 9 shows examples of regions generated from segmentation of an image, where the different regions may have different probability distribution functions. In particular, FIG. 9 is a diagram illustrating an example segmentation map 910 generated from an image 900. In FIG. 9, an image 900 of a scene of an environment of a vehicle (e.g., an autonomous vehicle) driving on a road is shown. In one or more examples, segmentation may be performed on the image 900 to generate the corresponding segmentation map 910 for the environment. The segmentation map 910 shows that the scene has been segmented into a number of different regions (or segments). For example, the segmentation map 910 is shown to have a total of five different regions. Each region can be associated with a specific type of object. For example, region 1 is associated with the vehicle itself, region 2 is associated with the road, region 3 is associated with the shoulder of the road (e.g., containing grass), region 4 is associated with trees, and region 5 is associated with the sky. Each of the different regions (e.g., regions 1, 2, 3, 4, and 5) can have a different probability distribution function.

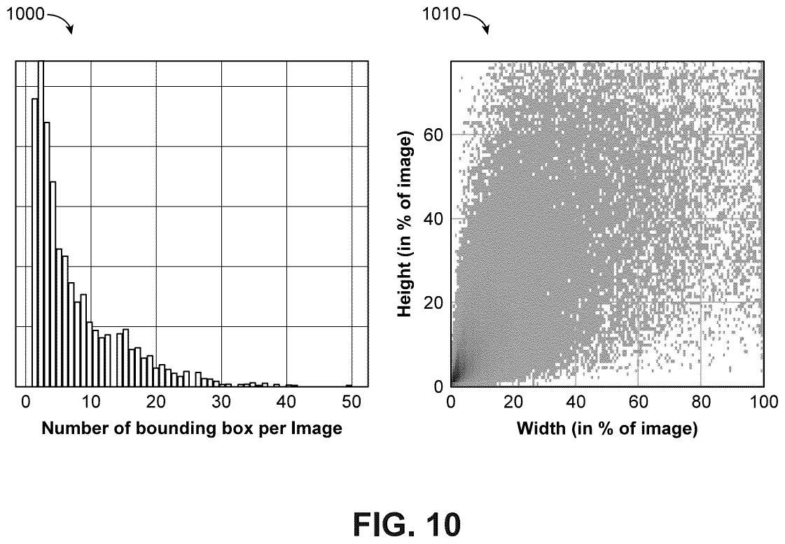

FIG. 10 are graphs 1000, 1010 illustrating example probability distribution functions for a density of candidate bounding regions for different object classes and for a size of candidate bounding regions, respectively. In FIG. 10, graph 1000 shows a distribution of different candidate bounding region densities per object class. For graph 1000, the x-axis denotes the number of candidate bounding regions per image, and the y-axis denotes the different types of objects. For example, a maximum number of candidate bounding regions for vehicles may be ten. Graph 1010 shows a distribution of different candidate bounding region sizes. For graph 1010, the x-axis denotes the width of the candidate bounding regions as a percentage of the image, and the y-axis denotes the height of the candidate bounding regions as a percentage of the image.

In one or more examples, a third type of NMS attack detector may be applied that uses an output of other tasks. For this third type of detector, the number of candidate bounding regions (e.g., that are output from the object detection model 620) can be reduced based on an output of one or more image processing operations on the images to generate a subset of candidate bounding regions. In one or more examples, the other tasks may include, but are not limited to, segmentation (e.g., to generate a segmentation mask that can be used to filter out objects prior to being input into NMS), generation of an attention map, and/or determining a known low-density region. In one or more examples, the output of the one or more image processing operations on the one or more images can include a segmentation mask, an attention map, and/or a known low-density region.

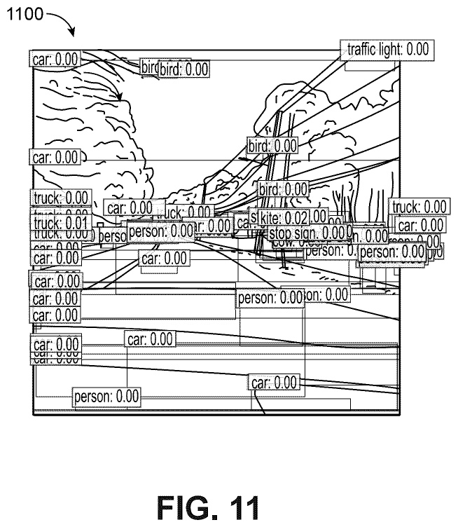

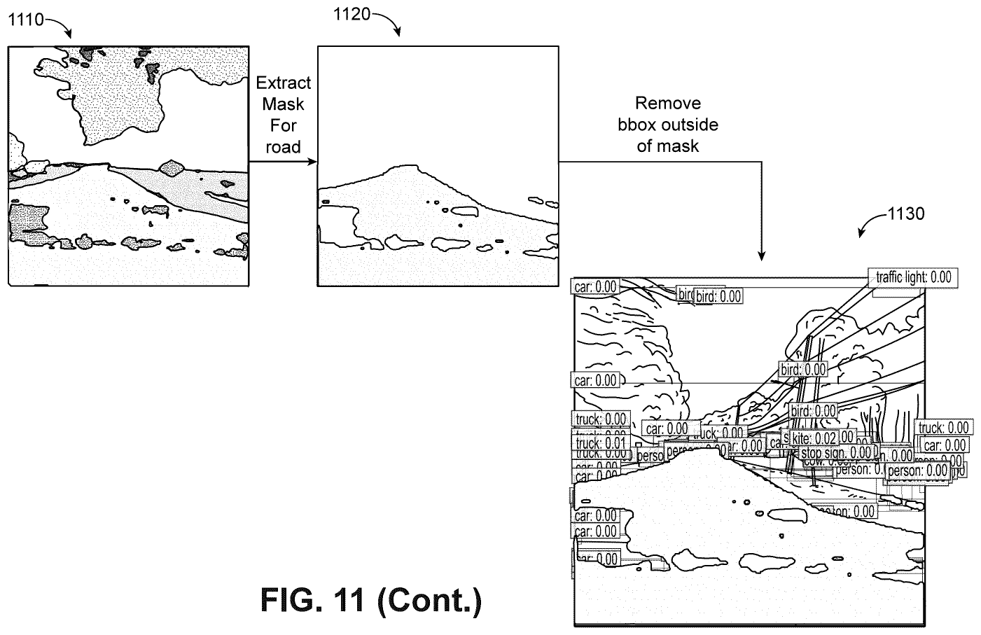

FIG. 11 shows an example of the third type of NMS attack detector, where a segmentation mask is used to reduce the number of candidate bounding regions (e.g., that are output from the object detection model 620) to generate a subset of candidate bounding regions. In particular, FIG. 11 is a diagram illustrating an example of reducing a number of candidate bounding regions using a segmentation mask. In FIG. 11, an image 1100 including a plurality of candidate bounding regions (e.g., determined by an object detection model) is shown. In one or more examples, segmentation may be performed on the image 1100 to generate a corresponding segmentation map 1110 for the environment. The segmentation map 1110 shows that the scene has been segmented into a number of different segments. Each segment, in the segmentation map 1110, can be associated with a different color. One of the segments, which is a segmentation mask 1120 associated with the road in the scene, can be extracted. The removal of the segmentation mask 1120 removes the candidate bounding regions that are associated with the area of the scene associated with the segmentation mask 1120. As such, with the removal (e.g., extraction) of the segmentation mask 1120, the number of candidate bounding regions (e.g., shown in image 1100) are reduced to generate a subset of candidate bounding regions (e.g., shown in image 1130). As such, image 1130 is shown to have a lower number of candidate bounding regions than image 1100. Note that even though the segmentation mask 1120 may be affected by the NMS attack (e.g., the segmentation mask 1120 may become a little distorted as a result of the attack), the use of the segmentation mask 1120 is still useful to reduce the number of candidate bounding regions.

FIG. 12 is a diagram illustrating an example of the effects of an NMS attack on a segmentation mask. In FIG. 12, an image 1200 of a scene of an environment of a vehicle (e.g., an autonomous vehicle) is shown. In one or more examples, segmentation may be performed on the image 1200 to generate a corresponding segmentation map 1210 for the environment. The segmentation map 1210 shows that the scene has been segmented into a number of different segments, where each segment in the segmentation map 1210 may be associated with a different color.

In one or more examples, the image 1200 may be affected by an NMS attack (e.g., a Daedalus attack). The segmentation map 1220 shows how the scene of the image 1200 has been segmented as a result of the NMS attack (e.g., a Daedalus attack). As such, segmentation map 1220 shows inconsistencies with segmentation map 1210. The segmentation is shown to be affected by the attack (e.g., Daedalus attack), but to a lesser extent.

In one or more aspects, the security model 660 (e.g., security solution) can use a plurality of the proposed detectors. The decision to select one detector over another other detector can be based on the perception task at hand and/or performance requirements (e.g., latency of the NMS). As previously mentioned, the security model 660 can be implemented (e.g., run) before or after the object detection model 620, or both. Depending upon the latency requirement (e.g., can the system afford to wait for all of the inputs and/or detectors), the security model 660 should be able to select which detectors to run. In one or more examples, the security model 660 can issue a warning after detection of an NMS attack. In some examples, the security model 660 can inform the application that an NMS attack was detected.

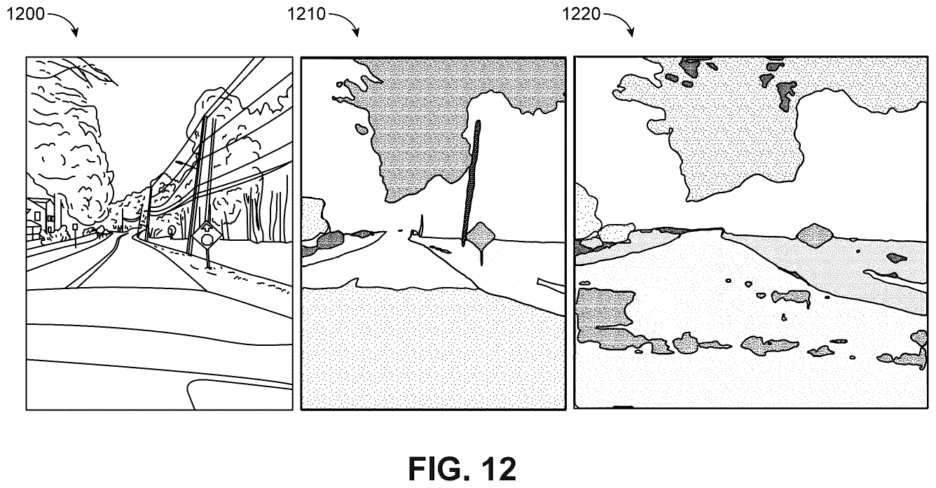

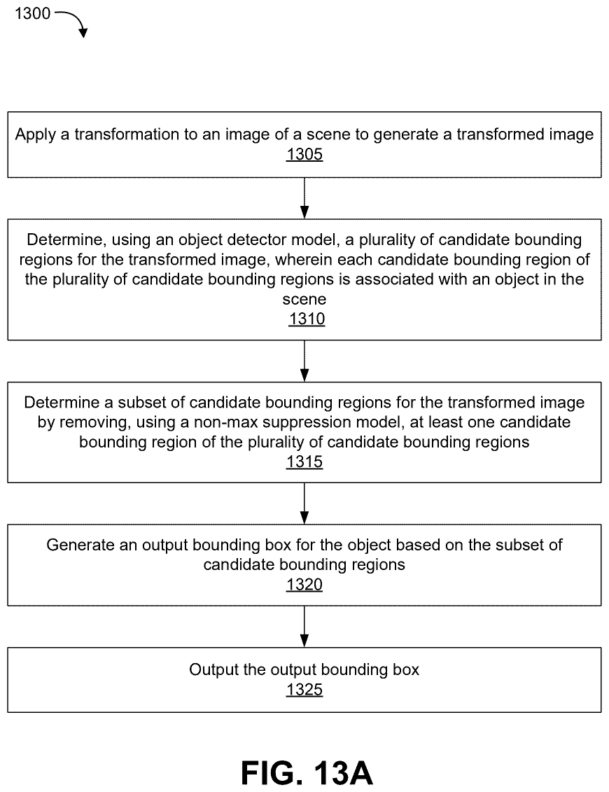

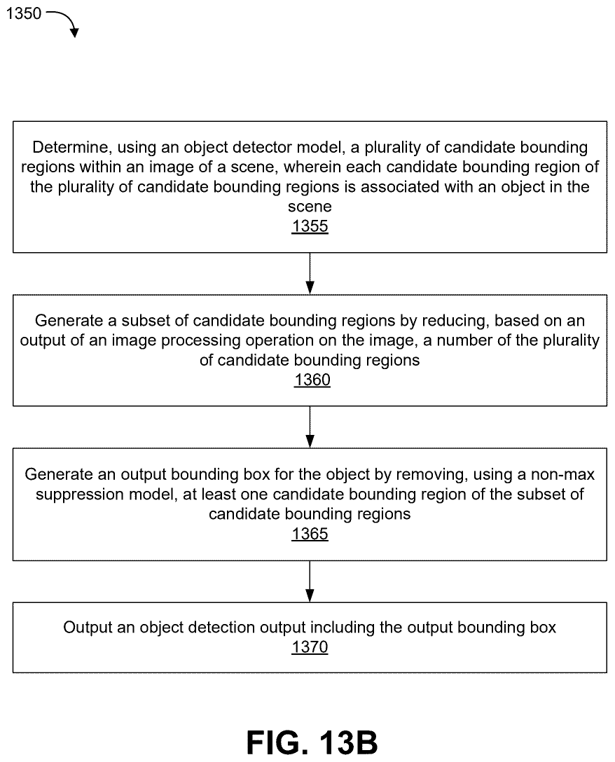

FIG. 13A is a flow chart illustrating an example of a process 1300 for object detection. The process 1300 can be performed by a computing device (e.g., SOC 100 of FIG. 1 and/or a computing device or computing system 1800 of FIG. 18) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1810 of FIG. 18 or other processor(s)). Further, the transmission and reception of signals by the computing device in the process 1300 may be enabled, for example, by one or more antennas and/or one or more transceivers (e.g., wireless transceiver(s)).

At block 1305, the computing device (or component thereof) can apply a transformation to an image of a scene to generate a transformed image. For instance, the computing device can obtain the image of the scene from an image sensor (e.g., which in some cases is part of the computing device). In some aspects, the transformation includes blurring, masking, inpainting, application of a diffusion machine learning model, compression, any combination thereof, and/or other transformation(s), such as discussed with respect to FIG. 6-FIG. 8. In some cases, the computing device (or component thereof) can determine, based on a context of the scene, the transformation to apply to the image. For instance, the context of the scene can be based on a luminance of the image, a brightness of the image, a type of environment of the scene (e.g., a highway environment with a large number of vehicles, an urban environment with a large number of vehicles, pedestrians, and/or other objects, a rural environment with a low number of vehicles, pedestrians, and/or other objects, etc.), any combination thereof, and/or other context.

At block 1310, the computing device (or component thereof) can determine, using an object detection model (e.g., the object detection model 620 of FIG. 6), a plurality of candidate bounding regions (e.g., bounding boxes) for the transformed image. Each candidate bounding region of the plurality of candidate bounding regions is associated with an object in the scene (e.g., a first candidate bounding region associated with a first object, a second candidate bounding region associated with a second object, a third candidate bounding region associated with a third object, and so on). In some cases, multiple candidate bounding regions can be associated with an object (e.g., as shown in FIG. 4).

As described herein, a security model (e.g., the security model 660 of FIG. 6) can be implemented (e.g., run) before and/or after the object detection model (e.g., the object detection model 620). The transformation can be applied to the image (to generate the transformed image) prior to the object detection model. In some aspects, the computing device (or component thereof) can also apply the security model after the object detection model. For example, in some aspects, the computing device (or component thereof) can output a warning message indicating a detected attack based on the plurality of candidate bounding regions being greater than a threshold number of candidate bounding regions. In some cases, the threshold number of candidate bounding regions is based on a context of the scene (e.g., based on a luminance of the image, a brightness of the image, a type of environment of the scene, etc.) and/or a plausibility determination based on a probability distribution function of objects within an environment of the scene (e.g., as described with respect to FIG. 8). In another example, according to some aspects, the computing device (or component thereof) can use an output of an image processing operation on the image to reduce a number of the plurality of candidate bounding regions. For instance, the output of image processing operation can include a segmentation mask (e.g., as shown in FIG. 9), an attention map, a known low-density region, any combination thereof, and/or other output. In some cases, the computing device (or component thereof) can determine whether to apply a threshold number of candidate bounding regions (e.g., to output the warning message when the plurality of candidate bounding regions is greater than the threshold number of candidate bounding regions) and/or an output of image processing operation on the image based on a perception task for detecting the object and/or a performance requirement. In some examples, the perception task can include detecting objects on a road within an environment of the scene for an autonomous driving application. In some examples, the performance requirement includes a latency requirement.

At block 1315, the computing device (or component thereof) can determine a subset of candidate bounding regions for the transformed image by removing, using a non-max suppression (NMS) model (e.g., the NMS model 640 of FIG. 6), at least one candidate bounding region of the plurality of candidate bounding regions. For example, as described previously, the NMS model 640 of FIG. 6 can be used to reduce a number of candidate bounding regions so that only candidate bounding regions with a high probability of containing an object are processed or output as an object detection output.

At block 1320, the computing device (or component thereof) can generate an output bounding box (e.g., bounding box(es) 650 of FIG. 6) for the object based on the subset of candidate bounding regions. At block 1325, the computing device (or component thereof) can output the output bounding box.

FIG. 13B is a flow chart illustrating an example of another process 1350 for object detection. The process 1350 can be performed by a computing device (e.g., SOC 100 of FIG. 1 and/or a computing device or computing system 1800 of FIG. 18) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1350 may be implemented as software components that are executed and run on one or more processors (e.g., processor 1810 of FIG. 18 or other processor(s)). Further, the transmission and reception of signals by the computing device in the process 1350 may be enabled, for example, by one or more antennas and/or one or more transceivers (e.g., wireless transceiver(s)).

At block 1355, the computing device (or component thereof) can determine, using an object detection model (e.g., the object detection model 620 of FIG. 6), a plurality of candidate bounding regions (e.g., bounding boxes) within an image of a scene. For instance, the computing device can obtain the image of the scene from an image sensor (e.g., which in some cases is part of the computing device). Each candidate bounding region of the plurality of candidate bounding regions is associated with an object in the scene (e.g., a first candidate bounding region associated with a first object, a second candidate bounding region associated with a second object, a third candidate bounding region associated with a third object, and so on). In some cases, multiple candidate bounding regions can be associated with an object (e.g., as shown in FIG. 4).

At block 1360, the computing device (or component thereof) can generate a subset of candidate bounding regions by reducing, based on an output of an image processing operation on the image, a number of the plurality of candidate bounding regions. For instance, the output of image processing operation can include a segmentation mask (e.g., as shown in FIG. 9), an attention map, a known low-density region, any combination thereof, and/or other output.

In some aspects, the computing device (or component thereof) can output a warning message indicating a detected attack based on the plurality of candidate bounding regions being greater than a threshold number of candidate bounding regions. In some cases, the threshold number of candidate bounding regions is based on a context of the scene (e.g., based on a luminance of the image, a brightness of the image, a type of environment of the scene, etc.) and/or a plausibility determination based on a probability distribution function of objects within an environment of the scene (e.g., as described with respect to FIG. 8).

At block 1365, the computing device (or component thereof) can generate an output bounding box (e.g., bounding box(es) 650 of FIG. 6) for the object by removing, using a non-max suppression (NMS) model, at least one candidate bounding region of the subset of candidate bounding regions. For example, as described previously, the NMS model 640 of FIG. 6 can be used to reduce a number of candidate bounding regions so that only candidate bounding regions with a high probability of containing an object are processed or output as an object detection output.

At block 1370, the computing device (or component thereof) can output an object detection output including the output bounding box (e.g., bounding box(es) 650 of FIG. 6).

As described herein, a security model (e.g., the security model 660 of FIG. 6) can be implemented (e.g., run) before and/or after the object detection model (e.g., the object detection model 620). The computing device (or component thereof) can generate the subset of candidate bounding regions based on the output of an image processing operation on the image based on the output of the object detection model (and thus after the object detection model). In some aspects, the computing device (or component thereof) can also apply the security model prior to the object detection model. For example, the computing device (or component thereof) can apply a transformation to the image of the scene. In some aspects, the transformation includes blurring, masking, inpainting, application of a diffusion machine learning model, compression, any combination thereof, and/or other transformation(s), such as discussed with respect to FIG. 6-FIG. 8. In some cases, the computing device (or component thereof) can determine, based on a context of the scene (e.g., based on a luminance of the image, a brightness of the image, a type of environment of the scene such as a highway environment or an urban environment, etc.), the transformation to apply to the image. In some cases, the computing device (or component thereof) can determine whether to apply the transformation to the image based on a perception task for detecting the object and/or a performance requirement. In some examples, the perception task can include detecting objects on a road within an environment of the scene for an autonomous driving application. In some examples, the performance requirement includes a latency requirement.

In some cases, the computing device configured to perform the process 1300 and/or the process 1350 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device configured to perform the process 1300 and/or the process 1350 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 and the process 1350 are each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Any of the processes described herein (e.g., the process 1300, the process 1350, and/or other process described herein) may be performed under the control of one or more computer systems (e.g., the computing device) configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 14 is an illustrative example of a deep learning neural network 1400 that can be used to perform object detection. An input layer 1420 includes input data. In some examples, the input layer 1420 can include data representing the pixels of an input video frame. The neural network 1400 includes multiple hidden layers 1422a, 1422b, through 1422n. The hidden layers 1422a, 1422b, through 1422n include “n” number of hidden layers, where “n” is an integer greater than or equal to one. The number of hidden layers can be made to include as many layers as needed for the given application. The neural network 1400 further includes an output layer 1424 that provides an output resulting from the processing performed by the hidden layers 1422a, 1422b, through 1422n. In some examples, the output layer 1424 can provide a classification for an object in an input video frame. The classification can include a class identifying the type of object (e.g., a person, a dog, a cat, or other object).

The neural network 1400 is a multi-layer neural network of interconnected nodes. Each node can represent a piece of information. Information associated with the nodes is shared among the different layers and each layer retains information as information is processed. In some cases, the neural network 1400 can include a feed-forward network, in which case there are no feedback connections where outputs of the network are fed back into itself. In some cases, the neural network 1400 can include a recurrent neural network, which can have loops that allow information to be carried across nodes while reading in input.

Information can be exchanged between nodes through node-to-node interconnections between the various layers. Nodes of the input layer 1420 can activate a set of nodes in the first hidden layer 1422a. For example, as shown, each of the input nodes of the input layer 1420 is connected to each of the nodes of the first hidden layer 1422a. The nodes of the hidden layers 1422a, 1422b, through 1422n can transform the information of each input node by applying activation functions to the information. The information derived from the transformation can then be passed to and can activate the nodes of the next hidden layer 1422b, which can perform their own designated functions. Example functions include convolutional, up-sampling, data transformation, and/or any other suitable functions. The output of the hidden layer 1422b can then activate nodes of the next hidden layer, and so on. The output of the last hidden layer 1422n can activate one or more nodes of the output layer 1424, at which an output is provided. In some cases, while nodes (e.g., node 1426) in the neural network 1400 are shown as having multiple output lines, a node has a single output and all lines shown as being output from a node represent the same output value.

In some cases, each node or interconnection between nodes can have a weight that is a set of parameters derived from the training of the neural network 1400. Once the neural network 1400 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1400 to be adaptive to inputs and able to learn as more and more data is processed.

The neural network 1400 is pre-trained to process the features from the data in the input layer 1420 using the different hidden layers 1422a, 1422b, through 1422n in order to provide the output through the output layer 1424. In an example in which the neural network 1400 is used to identify objects in images, the neural network 1400 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 1400 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1400 is trained well enough so that the weights of the layers are accurately tuned.

For the example of identifying objects in images, the forward pass can include passing a training image through the neural network 1400. The weights are initially randomized before the neural network 1400 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 1400, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1400 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1400 can perform a backward pass by determining which inputs (weights) most contributed to the loss of the network, and can adjust the weights so that the loss decreases and is eventually minimized.

A derivative of the loss with respect to the weights (denoted as dL/dW, where Ware the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1400 can include any suitable deep network. As described previously, an example of a neural network 1400 includes a convolutional neural network (CNN), which includes an input layer and an output layer, with multiple hidden layers between the input and out layers. An example of a CNN is described below with respect to FIG. 15. The hidden layers of a CNN include a series of convolutional, nonlinear, pooling (for downsampling), and fully connected layers. The neural network 1400 can include any other deep network other than a CNN, such as an autoencoder, a deep belief nets (DBNs), a Recurrent Neural Networks (RNNs), among others.

FIG. 15 is an illustrative example of a convolutional neural network 1500 (CNN 1500). The input layer 1520 of the CNN 1500 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1522a, an optional non-linear activation layer, a pooling hidden layer 1522b, and fully connected hidden layers 1522c to get an output at the output layer 1524. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 is the convolutional hidden layer 1522a. The convolutional hidden layer 1522a analyzes the image data of the input layer 1520. Each node of the convolutional hidden layer 1522a is connected to a region of nodes (pixels) of the input image called a receptive field. The convolutional hidden layer 1522a can be considered as one or more filters (each filter corresponding to a different activation or feature map), with each convolutional iteration of a filter being a node or neuron of the convolutional hidden layer 1522a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 1522a. Each connection between a node and a receptive field for that node learns a weight and, in some cases, an overall bias such that each node learns to analyze its particular local receptive field in the input image. Each node of the hidden layer 1522a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1522a is due to each node of the convolutional layer being applied to its corresponding receptive field. For example, a filter of the convolutional hidden layer 1522a can begin in the top-left corner of the input image array and can convolve around the input image. As noted above, each convolutional iteration of the filter can be considered a node or neuron of the convolutional hidden layer 1522a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1522a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1522a.

The mapping from the input layer to the convolutional hidden layer 1522a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1522a can include several activation maps in order to identify multiple features in an image. The example shown in FIG. 15 includes three activation maps. Using three activation maps, the convolutional hidden layer 1522a can detect three different kinds of features, with each feature being detectable across the entire image.

In some examples, a non-linear hidden layer can be applied after the convolutional hidden layer 1522a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1522a.

The pooling hidden layer 1522b can be applied after the convolutional hidden layer 1522a (and after the non-linear hidden layer when used). The pooling hidden layer 1522b is used to simplify the information in the output from the convolutional hidden layer 1522a. For example, the pooling hidden layer 1522b can take each activation map output from the convolutional hidden layer 1522a and generates a condensed activation map (or feature map) using a pooling function. Max-pooling is an example of a function performed by a pooling hidden layer. Other forms of pooling functions be used by the pooling hidden layer 1522a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1522a. In the example shown in FIG. 15, three pooling filters are used for the three activation maps in the convolutional hidden layer 1522a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1522a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1522a having a dimension of 24×24 nodes, the output from the pooling hidden layer 1522b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1522b to every one of the output nodes in the output layer 1524. Using the example above, the input layer includes 28×28 nodes encoding the pixel intensities of the input image, the convolutional hidden layer 1522a includes 3×24×24 hidden feature nodes based on application of a 5×5 local receptive field (for the filters) to three activation maps, and the pooling layer 1522b includes a layer of 3×12× 12 hidden feature nodes based on application of max-pooling filter to 2×2 regions across each of the three feature maps. Extending this example, the output layer 1524 can include ten output nodes. In such an example, every node of the 3×12×12 pooling hidden layer 1522b is connected to every node of the output layer 1524.

The fully connected layer 1522c can obtain the output of the previous pooling layer 1522b (which should represent the activation maps of high-level features) and determines the features that most correlate to a particular class. For example, the fully connected layer 1522c layer can determine the high-level features that most strongly correlate to a particular class, and can include weights (nodes) for the high-level features. A product can be computed between the weights of the fully connected layer 1522c and the pooling hidden layer 1522b to obtain probabilities for the different classes. For example, if the CNN 1500 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1524 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

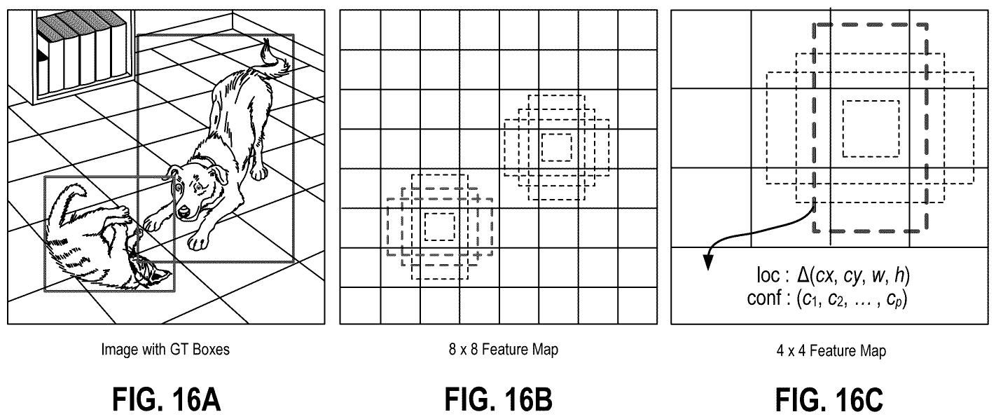

As previously noted, an object detector (e.g., object detection model 620 of FIG. 6) can use any suitable neural network based detector. One example includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 16A includes an image and FIG. 16B and FIG. 16C include diagrams illustrating how an SSD detector (with the VGG deep network base model) operates. For example, SSD matches objects with default boxes of different aspect ratios (shown as dashed rectangles in FIG. 16B and FIG. 16C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 16B) are matched with the cat, and one of the 4×4 boxes (shown in red in FIG. 16C) is matched with the dog. SSD has multiple features maps, with each feature map being responsible for a different scale of objects, allowing it to identify objects across a large range of scales. For example, the boxes in the 8×8 feature map of FIG. 16B are smaller than the boxes in the 4×4 feature map of FIG. 16C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 16A, all probability labels would indicate the background class with the exception of the three matched boxes (two for the cat, one for the dog).

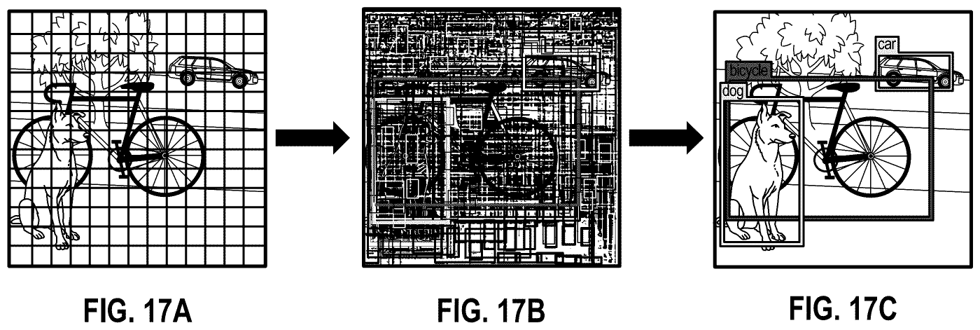

Another deep learning-based detector that can be used by an object detector (e.g., object detection model 620 of FIG. 6) to detect or classify objects in images includes the You only look once (YOLO) detector, which is an alternative to the SSD object detection system. FIG. 17A includes an image and FIG. 17B and FIG. 17C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 17A, the YOLO detector divides up the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 17B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image in FIG. 17B is 85% sure it contains the object class “dog.” There are 169 grid cells (13×13) and each cell predicts 5 bounding boxes, resulting in 1845 bounding boxes in total. Many of the bounding boxes will have very low scores, in which case only the boxes with a final score above a threshold (e.g., above a 30% probability, 40% probability, 50% probability, or other suitable threshold) are kept. FIG. 17C shows an image with the final predicted bounding boxes and classes, including a dog, a bicycle, and a car. As shown, from the 2545 total bounding boxes that were generated, only the three bounding boxes shown in FIG. 17C were kept because they had the best final scores.

FIG. 18 is a block diagram illustrating an example of a computing system 1800, which may be employed for defenses for latency attacks against non-max suppression for object detection. In particular, FIG. 18 illustrates an example of computing system 1800, which can be for example any computing device making up internal computing system, a remote computing system, a camera, or any component thereof in which the components of the system are in communication with each other using connection 1805. Connection 1805 can be a physical connection using a bus, or a direct connection into processor 1810, such as in a chipset architecture. Connection 1805 can also be a virtual connection, networked connection, or logical connection.

In some aspects, computing system 1800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1800 includes at least one processing unit (CPU or processor) 1810 and connection 1805 that communicatively couples various system components including system memory 1815, such as read-only memory (ROM) 1820 and random access memory (RAM) 1825 to processor 1810. Computing system 1800 can include a cache 1812 of high-speed memory connected directly with, in close proximity to, or integrated as part of processor 1810.

Processor 1810 can include any general purpose processor and a hardware service or software service, such as services 1832, 1834, and 1836 stored in storage device 1830, configured to control processor 1810 as well as a special-purpose processor where software instructions are incorporated into the actual processor design. Processor 1810 may essentially be a completely self-contained computing system, containing multiple cores or processors, a bus, memory controller, cache, etc. A multi-core processor may be symmetric or asymmetric.

To enable user interaction, computing system 1800 includes an input device 1845, which can represent any number of input mechanisms, such as a microphone for speech, a touch-sensitive screen for gesture or graphical input, keyboard, mouse, motion input, speech, etc. Computing system 1800 can also include output device 1835, which can be one or more of a number of output mechanisms. In some instances, multimodal systems can enable a user to provide multiple types of input/output to communicate with computing system 1800.

Computing system 1800 can include communications interface 1840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1840 may also include one or more range sensors (e.g., LiDAR sensors, laser range finders, RF radars, ultrasonic sensors, and infrared (IR) sensors) configured to collect data and provide measurements to processor 1810, whereby processor 1810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1840 may also include one or more Global Navigation Satellite System (GNSS) receivers or transceivers that are used to determine a location of the computing system 1800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1830 can include software services, servers, services, etc., that when the code that defines such software is executed by the processor 1810, it causes the system to perform a function. In some aspects, a hardware service that performs a particular function can include the software component stored in a computer-readable medium in connection with the necessary hardware components, such as processor 1810, connection 1805, output device 1835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for object detection, the apparatus comprising: a memory; and a processor coupled to the memory and configured to: apply a transformation to an image of a scene to generate a transformed image; determine, using an object detection model, a plurality of candidate bounding regions for the transformed image, wherein each candidate bounding region of the plurality of candidate bounding regions is associated with an object in the scene; determine a subset of candidate bounding regions for the transformed image by removing, using a non-max suppression model, at least one candidate bounding region of the plurality of candidate bounding regions; generate an output bounding box for the object based on the subset of candidate bounding regions; and output the output bounding box.

Aspect 2. The apparatus of Aspect 1, wherein the processor is configured to obtain, by an image sensor, the image of the scene.

Aspect 3. The apparatus of any of Aspects 1 or 2, wherein the transformation comprises at least one of blurring, masking, inpainting, application of a diffusion machine learning model, or compression.

Aspect 4. The apparatus of Aspect 3, wherein the processor is configured to determine, based on a context of the scene, the transformation to apply to the image.

Aspect 5. The apparatus of Aspect 4, wherein the context of the scene is based on at least one of luminance of the image, brightness of the image, or a type of environment of the scene.

Aspect 6. The apparatus of Aspect 5, wherein the type of environment of the scene is one of a highway environment or an urban environment.

Aspect 7. The apparatus of any of Aspects 1 to 6, wherein the processor is configured to output a warning message indicating a detected attack based on the plurality of candidate bounding regions being greater than a threshold number of candidate bounding regions.

Aspect 8. The apparatus of Aspect 7, wherein the threshold number of candidate bounding regions is based on at least one of a context of the scene or a plausibility determination based on a probability distribution function of objects within an environment of the scene.

Aspect 9. The apparatus of any of Aspects 1 to 8, wherein the processor is configured to use an output of an image processing operation on the image to reduce a number of the plurality of candidate bounding regions.

Aspect 10. The apparatus of Aspect 9, wherein the output of image processing operation comprises at least one of a segmentation mask, an attention map, or a known low-density region.

Aspect 11. The apparatus of any of Aspects 1 to 10, wherein the processor is configured to determine whether to apply at least one of a threshold number of candidate bounding regions or an output of image processing operation on the image based on at least one of a perception task for detecting the object or a performance requirement.

Aspect 12. The apparatus of Aspect 11, wherein the perception task comprises detecting objects on a road within an environment of the scene for an autonomous driving application.

Aspect 13. The apparatus of Aspect 12, wherein the performance requirement comprises a latency requirement.

Aspect 14. An apparatus for object detection, the apparatus comprising: a memory; and a processor coupled to the memory and configured to: determine, using an object detection model, a plurality of candidate bounding regions within an image of a scene, wherein each candidate bounding region of the plurality of candidate bounding regions is associated with an object in the scene; generate a subset of candidate bounding regions by reducing, based on an output of an image processing operation on the image, a number of the plurality of candidate bounding regions; generate an output bounding box for the object by removing, using a non-max suppression model, at least one candidate bounding region of the subset of candidate bounding regions; and output an object detection output including the output bounding box.

Aspect 15. The apparatus of Aspect 14, wherein the processor is configured to obtain, by an image sensor, the image of the scene.

Aspect 16. The apparatus of any of Aspects 14 or 15, wherein the processor is configured to output a warning message indicating a detected attack based on the plurality of candidate bounding regions being greater than a threshold number of candidate bounding regions.

Aspect 17. The apparatus of Aspect 16, wherein the threshold number of candidate bounding regions is based on at least one of a context of the scene or a plausibility determination based on a probability distribution function of objects within an environment of the scene.

Aspect 18. The apparatus of any of Aspects 14 to 17, wherein the output of the image processing operation on the image comprises applying at least one of a segmentation mask, an attention map, or a known low-density region.

Aspect 19. The apparatus of any of Aspects 14 to 18, wherein the processor is configured to apply a transformation to the image of the scene.

Aspect 20. The apparatus of Aspect 19, wherein the transformation comprises at least one of blurring, masking, inpainting, application of a diffusion machine learning model, or compression.

Aspect 21. The apparatus of Aspect 20, wherein the processor is configured to determine, based on a context of the scene, the transformation to apply to the image.

Aspect 22. The apparatus of Aspect 21, wherein the context of the scene is based on at least one of luminance of the image, brightness of the image, or a type of environment of the scene.

Aspect 23. The apparatus of Aspect 22, wherein the type of environment of the scene is one of a highway environment or an urban environment.

Aspect 24. The apparatus of any of Aspects 19 to 23, wherein the processor is configured to determine whether to apply the transformation to the image based on at least one of a perception task for detecting the object or a performance requirement.

Aspect 25. The apparatus of Aspect 24, wherein the perception task comprises detecting objects on a road within an environment of the scene for an autonomous driving application.

Aspect 26. The apparatus of any of Aspects 24 or 25, wherein the performance requirement comprises a latency requirement.

Aspect 27. A method of object detection, the method comprising: applying a transformation to an image of a scene to generate a transformed image; determining, using an object detection model, a plurality of candidate bounding regions for the transformed image, wherein each candidate bounding region of the plurality of candidate bounding regions is associated with an object in the scene; determining a subset of candidate bounding regions for the transformed image by removing, using a non-max suppression model, at least one candidate bounding region of the plurality of candidate bounding regions; generating an output bounding box for the object based on the subset of candidate bounding regions; and outputting the output bounding box.

Aspect 28. The method of Aspect 27, further comprising obtaining, by an image sensor, the image of the scene.

Aspect 29. The method of any of Aspects 27 or 28, wherein the transformation comprises at least one of blurring, masking, inpainting, application of a diffusion machine learning model, or compression.

Aspect 30. The method of Aspect 29, further comprising determining, based on a context of the scene, the transformation to apply to the image.

Aspect 31. The method of Aspect 30, wherein the context of the scene is based on at least one of luminance of the image, brightness of the image, or a type of environment of the scene.

Aspect 32. The method of Aspect 31, wherein the type of environment of the scene is one of a highway environment or an urban environment.

Aspect 33. The method of any of Aspects 27 or 32, further comprising outputting a warning message indicating a detected attack based on the plurality of candidate bounding regions being greater than a threshold number of candidate bounding regions.

Aspect 34. The method of Aspect 33, wherein the threshold number of candidate bounding regions is based on at least one of a context of the scene or a plausibility determination based on a probability distribution function of objects within an environment of the scene.

Aspect 35. The method of any of Aspects 27 to 34, further comprising using an output of an image processing operation on the image to reduce a number of the plurality of candidate bounding regions.

Aspect 36. The method of Aspect 35, wherein the output of image processing operation comprises at least one of a segmentation mask, an attention map, or a known low-density region.

Aspect 37. The method of any of Aspects 27 to 36, further comprising determining whether to apply at least one of a threshold number of candidate bounding regions or an output of image processing operation on the image based on at least one of a perception task for detecting the object or a performance requirement.

Aspect 38. The method of Aspect 37, wherein the perception task comprises detecting objects on a road within an environment of the scene for an autonomous driving application.

Aspect 39. The method of Aspect 38, wherein the performance requirement comprises a latency requirement.

Aspect 40. A method of object detection, the method comprising: determining, using an object detection model, a plurality of candidate bounding regions within an image of a scene, wherein each candidate bounding region of the plurality of candidate bounding regions is associated with an object in the scene; generating a subset of candidate bounding regions by reducing, based on an output of an image processing operation on the image, a number of the plurality of candidate bounding regions; generating an output bounding box for the object by removing, using a non-max suppression model, at least one candidate bounding region of the subset of candidate bounding regions; and outputting an object detection output including the output bounding box.

Aspect 41. The method of Aspect 40, further comprising obtaining, by an image sensor, the image of the scene.

Aspect 42. The method of any of Aspects 40 or 41, further comprising outputting a warning message indicating a detected attack based on the plurality of candidate bounding regions being greater than a threshold number of candidate bounding regions.

Aspect 43. The method of Aspect 42, wherein the threshold number of candidate bounding regions is based on at least one of a context of the scene or a plausibility determination based on a probability distribution function of objects within an environment of the scene.

Aspect 44. The method of any of Aspects 40 to 43, wherein the output of the image processing operation on the image comprises applying at least one of a segmentation mask, an attention map, or a known low-density region.

Aspect 45. The method of any of Aspects 40 to 44, further comprising applying a transformation to the image of the scene.

Aspect 46. The method of Aspect 45, wherein the transformation comprises at least one of blurring, masking, inpainting, application of a diffusion machine learning model, or compression.

Aspect 47. The method of Aspect 46, further comprises determining, based on a context of the scene, the transformation to apply to the image.

Aspect 48. The method of Aspect 47, wherein the context of the scene is based on at least one of luminance of the image, brightness of the image, or a type of environment of the scene.

Aspect 49. The method of Aspect 48, wherein the type of environment of the scene is one of a highway environment or an urban environment.

Aspect 50. The method of any of Aspects 45 to 49, further comprising determining whether to apply the transformation to the image based on at least one of a perception task for detecting the object or a performance requirement.

Aspect 51. The method of Aspect 50, wherein the perception task comprises detecting objects on a road within an environment of the scene for an autonomous driving application.

Aspect 52. The method of any of Aspects 50 or 51, wherein the performance requirement comprises a latency requirement.

Aspect 53. A non-transitory computer-readable medium having stored thereon instructions that, when executed by a processor, cause the processor to perform operations according to any of Aspects 27 to 39.

Aspect 54. An apparatus for object detection, the apparatus including one or more means for performing operations according to any of Aspects 27 to 39.

Aspect 55. A non-transitory computer-readable medium having stored thereon instructions that, when executed by a processor, cause the processor to perform operations according to any of Aspects 40 to 52.

Aspect 56. An apparatus for object detection, the apparatus including one or more means for performing operations according to any of Aspects 40 to 52.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for object detection, the apparatus comprising:
a memory; and
a processor coupled to the memory and configured to:
apply a transformation to an image of a scene to generate a transformed image;
determine, using an object detection model, a plurality of candidate bounding regions for the transformed image, wherein each candidate bounding region of the plurality of candidate bounding regions is associated with an object in the scene;
determine a subset of candidate bounding regions for the transformed image by removing, using a non-max suppression model, at least one candidate bounding region of the plurality of candidate bounding regions;
generate an output bounding box for the object based on the subset of candidate bounding regions; and
output the output bounding box.

2. The apparatus of claim 1, wherein the processor is configured to obtain, by an image sensor, the image of the scene.

3. The apparatus of claim 1, wherein the transformation comprises at least one of blurring, masking, inpainting, application of a diffusion machine learning model, or compression.

4. The apparatus of claim 3, wherein the processor is configured to determine, based on a context of the scene, the transformation to apply to the image.

5. The apparatus of claim 4, wherein the context of the scene is based on at least one of luminance of the image, brightness of the image, or a type of environment of the scene.

6. The apparatus of claim 5, wherein the type of environment of the scene is one of a highway environment or an urban environment.

7. The apparatus of claim 1, wherein the processor is configured to output a warning message indicating a detected attack based on the plurality of candidate bounding regions being greater than a threshold number of candidate bounding regions.

8. The apparatus of claim 7, wherein the threshold number of candidate bounding regions is based on at least one of a context of the scene or a plausibility determination based on a probability distribution function of objects within an environment of the scene.

9. The apparatus of claim 1, wherein the processor is configured to use an output of an image processing operation on the image to reduce a number of the plurality of candidate bounding regions.

10. The apparatus of claim 9, wherein the output of image processing operation comprises at least one of a segmentation mask, an attention map, or a known low-density region.

11. The apparatus of claim 1, wherein the processor is configured to determine whether to apply at least one of a threshold number of candidate bounding regions or an output of image processing operation on the image based on at least one of a perception task for detecting the object or a performance requirement.

12. The apparatus of claim 11, wherein the perception task comprises detecting objects on a road within an environment of the scene for an autonomous driving application.

13. The apparatus of claim 12, wherein the performance requirement comprises a latency requirement.

14. An apparatus for object detection, the apparatus comprising:
a memory; and
a processor coupled to the memory and configured to:
determine, using an object detection model, a plurality of candidate bounding regions within an image of a scene, wherein each candidate bounding region of the plurality of candidate bounding regions is associated with an object in the scene;
generate a subset of candidate bounding regions by reducing, based on an output of an image processing operation on the image, a number of the plurality of candidate bounding regions;
generate an output bounding box for the object by removing, using a non-max suppression model, at least one candidate bounding region of the subset of candidate bounding regions; and
output an object detection output including the output bounding box.

15. The apparatus of claim 14, wherein the processor is configured to obtain, by an image sensor, the image of the scene.

16. The apparatus of claim 14, wherein the processor is configured to output a warning message indicating a detected attack based on the plurality of candidate bounding regions being greater than a threshold number of candidate bounding regions.

17. The apparatus of claim 16, wherein the threshold number of candidate bounding regions is based on at least one of a context of the scene or a plausibility determination based on a probability distribution function of objects within an environment of the scene.

18. The apparatus of claim 14, wherein the output of the image processing operation on the image comprises applying at least one of a segmentation mask, an attention map, or a known low-density region.

19. The apparatus of claim 14, wherein the processor is configured to apply a transformation to the image of the scene.

20. The apparatus of claim 19, wherein the transformation comprises at least one of blurring, masking, inpainting, application of a diffusion machine learning model, or compression.

21. The apparatus of claim 20, wherein the processor is configured to determine, based on a context of the scene, the transformation to apply to the image.

22. The apparatus of claim 21, wherein the context of the scene is based on at least one of luminance of the image, brightness of the image, or a type of environment of the scene.

23. The apparatus of claim 22, wherein the type of environment of the scene is one of a highway environment or an urban environment.

24. The apparatus of claim 19, wherein the processor is configured to determine whether to apply the transformation to the image based on at least one of a perception task for detecting the object or a performance requirement.

25. The apparatus of claim 24, wherein the perception task comprises detecting objects on a road within an environment of the scene for an autonomous driving application.

26. The apparatus of claim 24, wherein the performance requirement comprises a latency requirement.

27. A method of object detection, the method comprising:
applying a transformation to an image of a scene to generate a transformed image;
determining, using an object detection model, a plurality of candidate bounding regions for the transformed image, wherein each candidate bounding region of the plurality of candidate bounding regions is associated with an object in the scene;
determining a subset of candidate bounding regions for the transformed image by removing, using a non-max suppression model, at least one candidate bounding region of the plurality of candidate bounding regions;
generating an output bounding box for the object based on the subset of candidate bounding regions; and
outputting the output bounding box.

28. The method of claim 27, wherein the transformation comprises at least one of blurring, masking, inpainting, application of a diffusion machine learning model, or compression.

29. A method of object detection, the method comprising:
determining, using an object detection model, a plurality of candidate bounding regions within an image of a scene, wherein each candidate bounding region of the plurality of candidate bounding regions is associated with an object in the scene;
generating a subset of candidate bounding regions by reducing, based on an output of an image processing operation on the image, a number of the plurality of candidate bounding regions;
generating an output bounding box for the object by removing, using a non-max suppression model, at least one candidate bounding region of the subset of candidate bounding regions; and
outputting an object detection output including the output bounding box.

30. The method of claim 29, further comprising outputting a warning message indicating a detected attack based on the plurality of candidate bounding regions being greater than a threshold number of candidate bounding regions.
